(19) United States
(12) Patent Application Publication
(10) Pub. No.: US 2008/0243666 A1
(43) Pub. Date: Oct. 2, 2008

(54) Transaction Management System and Method

(75) Inventor: Nicholas David Wingham Rowan, London (GB)

Correspondence Address: BROOKS KUSHMAN P.C., 1000 TOWN CENTER, TWENTY-SECOND FLOOR, SOUTHFIELD, MI, 48075, US

(73) Assignee: GUARANTEED MARKETS LTD, London (GB)

(21) Appl. No.: 10/597,370

(22) PCT Filed: Jan. 18, 2005
(86) PCT No.: PCT/GB2005/000178

§ 371 Date: Jul. 21, 2006

(30) Foreign Application Priority Data
Jan. 24, 2004 (GB) 0401570.7

(51) Int. Cl. G06Q 40/00

(52) U.S. Cl. 705/37

(57) ABSTRACT

A transaction management system manages the purchase of products and/or services by buyers from sellers, the system comprising: a data store for storing seller data. Said data comprises, for each of a plurality of sellers, a seller identifier and seller offer data indicating at least one product or service offered for sale; a program store storing processor implementable instructions; and a processor coupled to the data store and to the program store for implementing the stored instructions. Wherein the stored instructions comprise instructions for controlling the processor to implement a buyer interface to receive a purchase request from a buyer based on the seller offer data, thereby creating a transaction, the stored instructions further comprising instructions for controlling the processor to implement an investment interface to receive investment data from an investor, the investment data including a plurality of investment criteria for an investment fund, thereby creating the investment fund; and provide the investment data to buyers and sellers able to meet the plurality of investment criteria for the investment fund.

### FIELD OF THE INVENTION

The present invention relates to the field of online commerce. In particular it relates to the operation of electronic markets in which there are a plurality of both sellers and buyers.

### BACKGROUND OF THE INVENTION

Buying and selling online is conducted through a variety of mechanisms for matching the buyer and seller. These mechanisms include online catalogues, auctions, bid/ask systems, aggregating of buyers, request-for-quote services and bulletin board listings. Each mechanism is strong for certain types of transaction and weak for others.

The mechanisms above can be divided between those that allow immediate purchasing of pre-determined goods or services and those that accommodate irregular purchase requests but require more time for a purchase to complete.

An online catalogue of the type accessed at Amazon.com for example allows goods that have been described by the seller to be displayed to buyers at a price set by the seller. Similarly items auctioned on sites such as ebay.com are described by the seller but he then waits to see what price the market will pay for his offering. Bid/ask services such as that operated by Priceline.com and described in U.S. Pat. No. 5,794,207 require buyers to define a specific item or range of items to be purchased, typically an airline ticket between two points in a given date range, then wait to see if that need will be matched from a seller's database of pre-described offerings.

By contrast a buyer accessing a request-for-quote service such as that operated by guru.com is able to define his particular needs of the moment, a day of web design work at a specified location for instance, and then receive quotes from sellers who, having digested his requirements, quote a price at which they are willing to fulfill his need. This is time consuming for all concerned. Buyers must wait for a range of sellers to reply to their request to be sure of a fair price. Sellers must take the time to understand buyers' requirements and bid, knowing they may not be successful in getting the business.

The time consuming nature of online transactions in which the buyer is able to define his exact needs rather than shopping between various options pre-defined by sellers makes existing mechanisms impracticable for many transactions. They include short notice purchases or small purchases where the sum involved does not merit the attention of sellers or the waiting of buyers.

Ideally, in many markets, a buyer would wish to define his exact requirements of the moment and immediately be given a list of sellers specifically available and ready to meet that need. For instance his need might be “I want a temporary secretary to work from 2.00 to 6.00 this afternoon at my office”. He would then wish to see an immediate list of sellers who were (a) qualified to work as secretaries (b) in the vicinity of his office (c) willing to work this afternoon (d) currently willing to accept assignments at short notice (e) currently willing to accept assignments of only a few hours duration (f) could be contacted in time to receive details of this period of work.

Existing mechanisms are of little use to such a buyer. A bulletin board for instance will reveal a list of possible secretaries who can be emailed to see if they meet the characteristics above. An auction would be too time consuming for the buyer who could more easily phone a temporary worker supply agency. An online catalogue that simply allows the buyer to browse a list of offerings is again too time consuming for this buyer. Bid/ask type services require the buyer to input the price he will pay rather than allowing a market rate to be established.

To overcome this gap in the art the present inventor has previously disclosed elements of an online buyer/seller matching system called “GEMs”. Such a system is defined by an ability to take in a buyer's requirements and immediately construct options specific to his needs based on broader inputs from any number of sellers. Any of these options can then be purchased immediately. Such a system could run a plurality of markets in different sectors, for example such markets might include: bicycle hire, hire of a driving instructor or short notice office cleaning services.

FIG. 1. shows the buyer input screen for such a system as completed by a buyer who is seeking to book a temporary secretary. FIG. 2 shows the options returned immediately by such a system. These are not bulletin board style listings showing potential sellers who may possibly be available and possibly be interested in this transaction. The are specific options built around the buyer's inputs priced and ready for purchase.

Such a system holds considerable information about each seller which can be searched in the light of a specific buyer's enquiry. Each seller displayed on the screen represented at FIG. 2 has previously specified parameters within which they are willing to sell. These may include geographical area, period-of-notice for an assignment and length of assignment. This information is stored. All of those parameters are met by this requirement for each seller on the screen. The system has also checked that the seller is showing availability in an online availability diary this afternoon and that their diary of times when they undertake to be reached, for instance by mobile phone text message or email, would allow them to be notified of this transaction in time. The buyer can choose any one of these sellers and the system will inform the individual of the assignment regarding them as sold and making the required amendments to their availability diary.

Aspects of the GEMs system have been disclosed in publications by the present inventor. An overview of one embodiment of such a system will now be provided to illustrate one form of underlying architecture for the present invention. Referring first to FIG. 3, this shows a generalised embodiment 300 of a system that might underlie the present invention. Such a system would run a number of markets in different sectors, examples of sectors include: secretarial services, office rental and vehicle hire.

A communications network 303 is connected to seller terminals 301a and b and buyer terminals 302a and b and to a system communications interface 304. The communications network may comprise any conventional communications network such as a telephone network or the Internet. The communications network couples the buyer and seller terminals to the system communications interface 304 to provide user interfaces to the system to allow buyers and sellers to request and execute transactions using the system.

The communications interface 304 is coupled to a Communications Processor 305 which creates screens and messages for communicating with buyer and seller terminals 302 and 301. The communications processor is connected to an application processor 306 for providing transaction management applications. Application processor 306 is also coupled to a system service provider terminal 308 to allow a system service provider/operator direct access to aspects of the system to which access via communications network 303 is restricted for security reasons. Thus service provider terminal 308 may be used for system management, account management, program code updating, setting a mark-up on each transaction within the system for operator revenue purposes and similar functions. In an alternative embodiment service provider terminal 308 may be connected through a wider communications medium such as the Internet.

Application processor 306 is coupled to data store 307 storing system-related data. It is also able to communicate with external servers that perform specific additional tasks for the benefit of system users. Thus application processor 306 can process data for output to buyer and seller terminals 302 and 301 and communications processor 307 can access the data to send and receive messages to and from terminals 302 and 301. Thus data in data store 307 is indirectly accessible via buyer and seller terminals 302 and 301.

The communications interface 304, Communications Processor 305, the application processor 306 and the data store 307 may all be provided within a single general purpose computer or these functions may be distributed over a plurality of machines in a manner well known to those skilled in the art.

The communications network 303 in this embodiment is the Internet to which are coupled buyer terminals 302a and b and seller terminals 301a and b. Also coupled to Internet 303 is a gateway (not shown) to a mobile phone network 309 (or, more generally, any mobile communications network) which communicates with a mobile station 311, such as a phone handset, using base transceiver station 310.

FIG. 4. illustrates a preferred embodiment for the system's architecture within a central server. Communications Processor 305 interacts with communications interface 304 to receive inputs and forward output communications to buyers and sellers. Application server 306 contains software modules allowing new users accessing the system through the communications network to register as sellers 421 or buyers 422, or both. Transaction management module 423 extracts market rules information from the data store to govern information displayed to users in a particular market and the prioritization of searches. Assembly of options module 424 receives lists of relevant sellers after a search and applies rules on their filtering and display. In its simplest embodiment this module sends all sellers returned by the search to the communications processor 305. Price Construction Module 425 takes the list of sellers produced by Assembly of Options Module 424 and constructs the unit price at which each seller will fulfill this buyer's specified needs.

Once a buyer has selected a seller he wishes to purchase, post sale management module 426 compiles the information about the buyer and transaction that is required to inform the seller of all required details of the sale. Payment transfer module 427 ensures value is transferred from buyer to seller according to instructions in the market rules data store. This might involve credit card processing, transfer of digital value, holding sums in escrow or raising of an online invoice. It may entail breaking the transaction down into parts, the completion of each triggering part payment. Typically this could be achieved by means of a timesheet signed by buyer and seller using their system passwords at the end of each week of a booking. All these processes will be familiar to one skilled in the art and can be performed by widely available software.

User maintenance module 428 applies rules to the seller and buyer data store as instructed through the service provider terminal 308. These might include for instance generating email to any user who has not been active in the last 6 months asking that they confirm the email address, and therefore their identity, is still valid.

The data store 307 comprises firstly a database of sellers 431. For each seller this includes unique identifying code, name, password, date of birth, contact details, time and date of registration, unit price to be charged to buyers, history of transactions performed plus earnings and details of how payments arc to be transferred. For each seller there is additional data stored which can be changed at any time by the seller to which it pertains. Selling parameters record 431a stores that seller's preferences for sales, for instance how far from their base travel code they are willing to travel. Seller availability record 431b stores data input by the seller about the times when they are available to be sold by the system. Seller contractibility record 431c stores data of the times the seller undertakes to be available for contact by the system and the means by which messages should be sent.

Buyer database 432 includes information about each buyer on the system. This includes unique identifying code, name, administrator password, headquarters address, time and date of registration, details of other users within the buyer's account allowed to buy on its behalf (named members of staff for example), how payments are to be collected, history of transactions and payments made and the information to be displayed to sellers, for instance showing locations of the buyer's buildings at which they may be required to work.

Transaction database 433 records details of all transactions on the system. A preferred embodiment of this database includes the following record of any purchase or partly completed purchase: unique identifying code, market in which purchase was made, identity of buyer, identity of seller, time purchase initiated, number of units bought (hours of work for instance), dates units were to be supplied, times of day units were to be supplied, price paid per unit, selling parameters pertaining to this transaction and current status of the transaction which can be only one of the following exemplary list: waiting for seller confirmation/not confirmed/confirmed/in progress/cancelled/completed.

Market rules database 434 stores information pertaining to each market sector. Wording and options required to make up screens or messages for the user are extracted by communications processor 304. Market rules database 434 also stores rules on admission to a market, for instance “only sellers over 18 permitted” or “no more than 50 hours to be sold by any individual seller in one 7 day period”.

In the above-described aspects of the system communication between the system operator or intermediary and/or buyer and/or seller may be by any convenient communication means, but the system is particularly suited to implementation using an electronic communications network such as the Internet, and Intranet, or an Extranet, or wireless mobile communications.

In preferred embodiments the system is implemented on general purpose computer systems using appropriate software. The software may comprise instructions in one or more of HTML. XML, Java, Perl or other programming languages. Thus aspects of the system may be embodied in computer program code, either as separate applications or parts of a single program. As the skilled person will appreciate, such program may comprise source, object or executable code and code may be implemented on a single machine or shared between different hardware platforms. Such program code may be provided on any conventional carrier medium such as tape, disk, CD-ROM, programmed memory or on an electrical or optical signal carrier. The processor implementable instructions of the buyer and seller terminals may be stored on a network server and provided to the terminal as needed, for example as an Internet data page or web page.

Processes used in such a system will now be described. For ease of understanding the operation of the system will be described with reference to a specific example of the system's use, that of providing temporary secretaries to employers. However use of the system is not restricted to this application.

### Listing Goods or Services to be Sold

A new seller will typically enter the system through a portal accessed via the communications network 303 and constructed by the communications interface 304. This page is able to activate the Seller Registration Module 421. Having taken details of the individual or company, this module then offers a selection of markets in which anyone might register to sell. Thus a new seller might be asked “what do you wish to sell” and then offered a first selection list which includes “my time”. This response prompts a second list from which she chooses “formal temporary work” and then “secretarial work”. A seller can choose to sell in multiple market sectors. A seller may not be named as an individual but simply as “secretary from XYZ Agency”. They are then invited to input the pricing data that allows their price for a transaction for which they are applicable to be constructed. In its simplest embodiment this requires only that they specify a flat-rate price for each unit of sale or part thereof. In the temporary work market the unit of sale is hours.

Thus the system knows the individual's name, contact details, including email address and optional mobile phone number, and that she wishes to sell her time as a temporary secretary at, for example, $8.35 an hour. These details are recorded in seller database 431.

At this point the seller registration module 421 asks the questions that allow this user's parameters for any potential sale to be stored in the seller parameter record 431a. A list of parameters relevant to sales in the secretarial market are accessed from the market rules database 434. They may include:
Geography (for example: “My home postal code is X and I will not work more than Y miles from that point”)
Size of purchase (for example: “I will not accept bookings of less than 4 hours” or “I will not accept bookings lasting more than 10 working days”)
Period of notice for purchase (for example: “I only accept bookings where I have at least 24 hours notice of the job”)

Additionally the seller may be able to define specific buyers registered on the buyer database 432 with whom they are unwilling to trade. This is recorded on the seller parameter record 431a.

The new seller is then offered a blank diary of time blocks, possibly in half hour increments, covering each day for the remainder of the current week. She can click through to further pages covering following weeks. By selecting certain blocks she is able to select the precise times when she is available to work. This is stored in the seller availability diary 431b. By default this diary remains blank with no availability until the seller has input details of her willingness to work.

In a further embodiment the seller is now presented with a second set of diary pages and asked to input times when she undertakes to be contactable by the system. These are periods when she will be logged on to receive email or will have her mobile phone switched on and about her person to receive text messages. This data is stored in the seller contactability record 431c.

Thus it will be clear that the seller database 431 now holds details of the individual's identity (including password), market or markets in which they wish to sell, their unit price, the constraints on any sale they will accept, the times they are available to sell their chosen goods or services sold by the system and the times at which they can be contacted by the system. Any part of this information can be changed at any time by the seller logging on and triggering the user maintenance module 427. This will display current choices stored in the seller's parameter record 431a, availability diary 431b and contactability record 431c. The seller can then choose to overwrite her current preferences.

The above example pertains to a potential seller wishing to sell their time. It will be clear the architecture described could equally accept listings for other services. For example: load space on trucks, domestic storage capacity, sales of organic produce or childcare. In each case the market rules database 434 would provide a list of relevant parameters to be completed by the seller. An example of the selling parameters by which sellers can define their willingness to sell based on a buyer's specific needs for some further markets will now be given.

| MARKET | UNIT OF SALE | SELLING PARAMETERS |
|---|---|---|
| Overnight accommodation | Night | Length of stay/time of arrival/time of departure/ |
| | | number of people in room/smoker or non-smoker/ |
| | | period of notice to hire |
| Hire of agricultural tractors | Hour | Distance to buyer/anticipated hours of work within |
| | | the hire/length of hire/period of notice to hire |
| Local deliveries | Mile | Period of notice to pick up/distance from seller |
| | | postalcode to pick up point/length of journey/ |
| | | distance from seller postalcode to drop-off point/ |
| | | weight of object to be delivered/size of object to be |
| | | delivered |
| Specially commissioned | Kilogram | Smallness of cake/largeness of cake/style of cake |
| home cake baking | | (selected from drop down boxes)/period of notice |
| | | before delivery/delivery method/additional |
| | | trimmings (selected from drop down boxes) |

### The Purchase Process

A new buyer accesses the system through communications interface 304 and is shown a generic welcome page generated by communications processor 305. From this the new buyer is able to trigger Buyer Registration Module 422. This sends pages requesting information, validates that information and uses it to populate a record in buyer database 432. Confirmation of the buyer's means to pay may be obtained through a link to an external agency such as a credit card supplier using communications network 303 before purchasing is allowed. This process is well known to those in the art.

A buyer wishing, and permitted, to make a purchase can trigger the transaction management module 423. This will offer a page such as that shown in FIG. 1. that establishes the following. (a) What he wishes to purchase (for example: the time of a temporary secretary) This information is sent to the market rules database 434 which provides the parameters which must be defined to enable a search of the seller database 431. (b) The quantity he wishes to purchase (for example by defining a period of daily hours which the system can multiply by the number of days input at the next step). (c) The times he wishes to purchase (for example: by defining a start and end date for a booking). (d) The geography in which he wishes the purchase to be realized (for example: place of work is postal code Y).

Transaction management module 423 will ensure all required information is in place before beginning a search. Once the required inputs have been completed the transaction management module creates a record on the transaction database 433. A unique identifier code for this transaction is established at the time of storage. The transaction management module 423 then initiates a search of the seller database 431 based on the buyer inputs. The search is performed by assembly of options module 424. It excludes those sellers who are among any of the following. (a) Not selling the services/goods the buyer wishes to purchase. (b) Not willing to sell in the area defined by the buyer. (c) Not willing to sell the number of units (for example hours) demanded by the buyer. (d) Not willing to sell with the period of notice for this transaction. (e) Not available at the dates and times the buyer requires. (f) Not contactable in the time required before the purchase.

Thus the assembly of options module 424 is able to return a list of any sellers on the database who meet the following conditions. (a) Selling the services or goods required by the buyer. (b) Willing to sell in the geography required. (c) Willing to sell with the period of notice specific to this job. (d) Available for the times and dates required. (e) Contactable in time for this booking.

This list is sent to price construction module 425. In it simplest embodiment, this module looks up the unit price for each seller on the list, such data being held in seller database 431 and multiplies it by the number of units for this sale. Alternatively it may use the selling parameters of the present requirement as outlined in the screen shown in FIG. 1, coupled with a list of pricing preferences from each user, to construct a specific price for this one transaction for each seller. It may also add a mark-up input by the system operator through service provider terminal 308. This provides revenue for the market operator and is retained during any subsequent transfer of payment between buyer and seller. Alternatively the market operator might invoice either party for its transaction fee, or subscription fee, at a future date.

This list of options and their prices is stored in the transaction database 433 against the unique identifier for this query. If no sellers are returned the transaction management module 423 creates a message for the buyer suggesting a change of requirements.

The list of sellers and prices thus stored are now sent by the communications processor 304 and the communications interface 304 to the buyer terminal 302. Before doing so assembly of options module 424 may apply rules such as “display in price order from left to right putting identically priced sellers in alphabetical order” or “only display a maximum of 20 sellers on one screen”. Such rules would be input from service provider terminal 308.

One embodiment of such a page is represented in FIG. 2. If the buyer selects “purchase” on any option or options presented to him, that information is stored in the transaction database 433. A page of information for the seller has to be completed by the buyer and payment is arranged according to instructions in the market rules database 434 by payment transfer module 427. This module will access proprietary software well known to those in the art such as credit card approval, transfer of digital value between users on the system or invoice generation and return a “payment OK” flag to be recorded on Transaction Database 433.

Once payment arrangements have been confirmed the post sale management module 426 is triggered. This performs the following tasks. (a) Confirms the seller is still available. If they have removed their availability or been bought by another conflicting buyer since the search showed them to be available the buyer is advised with a message. (b) Removes the appropriate availability from the seller's record in the seller database 431. (c) Creates a message for the chosen seller revealing the buyer's identity stored in buyer database 432 and adding details of his purchase from the transaction database 432. In a temporary work transaction these would include: place of work, hours of work, days to be worked and information input by the buyer to be passed to the seller. (d) Looks up contact details on the seller database 431 and directs the message to email or mobile phone for instance via the communications processor 304. (e) Monitors that the seller confirms they will undertake the assignment before the start of work time. If they do not a message is generated for the buyer advising that the seller has not confirmed and the buyer may wish to re-book. (f) Triggers release of payment from escrow funds at a specified point based on rules in the market rules database 434 (for example 48 hours after completion of the transaction). In a temporary work market this would be likely to be based on completed timesheets each of which triggers an invoice. Online timesheets may be based on technology such as Web Timesheet from Adeo Software or the Time product from Artologik Software

It will be appreciated that modules listed above could be combined in practice. Their listing is purely illustrative of the functions to be performed and is not intended to define the system's structure.

### Benefits of the System

This is a “spot market” online. Existing systems for buyer/seller matching tend not to allow immediate purchasing from an infinite number of sellers who may have entered the market only minutes earlier. Online bulletin boards offer listings of sellers who may be available for a general need. Internet auctions require time consuming bidding. Using bid/ask systems the buyer must define parameters of the potential purchase which has to be matched by a precise offering defined by the seller.

“GEMs” type markets such as that just described provide a list of named sellers any one of whom can be booked immediately for a buyer's specific requirements. Unlike online catalogues these markets are able to construct a specific offering for a buyer's needs based on much more general inputs by a plurality of potential sellers.

There are potential enhancements to a system as described above that are already in the public domain:

### Grading of Sellers Embodiment

In this embodiment user maintenance module 428 promotes sellers up a ladder of grades as they complete specified numbers of trades and meet other conditions that may include (a) minimum number of counterparties (b) maximum number of outstanding transactions which are in dispute with the counterparty (c) maximum number of incidents when the seller was not contactable at a time when they had committed to being so. Buyers can view relevant sellers produced by a search for the buyer's requirements listed by their grades in the market. Grading data is stored on the seller database 431. For exemplary purposes there may be 7 levels of user: Entry Level, then grades 1 to 6 with 6 being the highest graded users. Users may move automatically through grades as the user maintenance module 427 periodically sweeps the seller database checking number of units sold in each market. Buyers too may be graded similarly.

### Market Overview Embodiment

By sweeping details of past transactions stored in the transaction database 433 including the sale price, times, dates and geographical point required by buyer a market overview module would be able to plot trends in the market for users. Anyone defining a market sector, a geographical area and a time period can then see data which might reflect the following averaged data. (a) Number of units sold in that geographical area/timeframe. (b) Average price of units in that geographical area/timeframe. (c) Number of sellers listing their availability in that geographical area/timeframe. (d) Range of periods of notice of purchases in that geographical area/timeframe.

It will be appreciated that this enables potential sellers to make decisions about market entry. Established sellers can identify patterns of demand. Buyers can select the times or geographies when they can purchase more cheaply.

### Related Applications and Prior Art

WIPO patent application WO 02/091100 discloses a GEMs system that allows the transactions of high grade sellers to be economically underwritten by the system operator. Underwritten transactions might have a monetary amount attached that specifies the maximum that can be spent on a replacement purchase. This document is incorporated herein by way of reference material.

UK patent application 0329203.4 discloses how a GEMs system might resolve disputes between users when a transaction has failed. This includes the means for either party to declare a transaction in dispute and freeze the associated monies. A methodology for resolving that dispute and apportioning blame to the appropriate party who may then be downgraded in a graded market is disclosed.

It has been previously disclosed that GEMs type markets should be able to facilitate loans between users in the book “Net Benefit” published by the present inventor in 1999.

It is known that a variety of institutions already offer automated investment opportunities. Services include so called “sweep accounts” which calculate the most desirable stocks or financial instruments for surplus account balances. Such services are outlined in U.S. Pat. No. 4,751,640. Said services include those available in December 2003 at www.sovereignbank.com/corporate/investments/invautoinv.asp and www.swbanktx.com/invest/auto_invest.asp. Another form of automated investment involves artificial intelligence applied to the performance of stocks or financial instruments. This concept has been developed and disclosed by author Ray Kurzweil and was available commercially in December 2003 at, for example, www.deepinsight.com/.

Other aspects of automated investment include technology that matches an investor's needs with a broker's selected investment products as outlined in WO 01/43037 (PCT/US00/33740). Automated anlaysis of stock pricing history for the benefit of financial advisors is covered by WO 01/013313 (PCT/US00/40666). Automatic placing of trades on a stock market or other formal investment exchange is covered in

WO 01/41006 (PCT/US99/29324). Likewise “stop orders” for sales in a stock market can be automated as disclosed in U.S. provisional application No. 60/185,047. However, these services focus on formal investment opportunities in companies and financial products, not direct investment in individual traders and transactions in an underlying marketplace of physical purchases.

It is also known that “microcredit”, the handling of small sums of aggregated money by communities, has been developed online. Using this means, a village would typically create a fund into which small payments can be made, the fund is then used to create loans for local people who pay back the capital plus interest which is returned to those who put money into the fund. The concept was popularised by The Grameen Bank http://www.grameen-into.org/mcredit/cmodel.html. It is commercially available from a variety of institutions online including, in December 2003, http://www.pnbindia.com/c_traders.htm. However, such funds tend to be broad ranging and based on scant information when compared to the range of metrics and investment opportunities that are taken for granted by users of more mainstream financial institutions.

Likewise WO 00/11671 (PCT/US99/19014) discloses a means of matching individual entrepreneurs with investors based on progressive disclosure of information about each entrepreneur. This is intended for occasional “business angel” investments based on a high degree of knowledge about an individual and relies on considerable amounts of time being taken by the investor to peruse details of each investment option and make a personal decision about the potential investment recipient's plans.

There therefore exists a need for a means of simultaneously (a) accepting small or large amounts of investment and (b) making small, precise, investments that achieves the following objectives: (i) allow investors to shape highly distinctive opportunities based on their own preferences (ii) provide detailed metrics about performance of investments (iii) entail low overheads in allocation and collection of funds (iv) allow investment funds to be automatically allocated where there is most need and highest return.

### SUMMARY OF THE INVENTION

According to an aspect of the invention, there is provided a transaction management system for managing the purchase of products and/or services by buyers from sellers, the system comprising:
a data store for storing seller data comprising, for each of a plurality of sellers, a seller identifier and seller offer data indicating at least one product or service offered for sale;
a program store storing processor implementable instructions; and
a processor coupled to the data store and to the program store for implementing the stored instructions,
wherein the stored instructions comprise instructions for controlling the processor to implement a buyer interface to receive a purchase request from a buyer based on the seller offer data, thereby creating a transaction, the stored instructions further comprising instructions for controlling the processor to implement an investment interface to:
   receive investment data from an investor, the investment data including a plurality of investment criteria for an investment fund, thereby creating the investment fund; and
   provide the investment data to buyers and sellers able to meet the plurality of investment criteria for the investment fund.

The invention thus provides a transaction management system that facilitates market investment. Investors are able to set up investment funds having specific investment criteria. Buyers and sellers may then be provided with details of investment funds for which they, or their transactions, are eligible.

Preferably, the data store is further for storing buyer data comprising, for each of a plurality of buyers, a buyer identifier. The data store may further be for storing transaction data comprising, for each of a plurality of transactions, a transaction identifier, a buyer identifier, and a seller identifier. Preferably, the transaction data in the data store further comprises, for each of the plurality of transactions, a successfully completed transaction flag and a disputed problem transaction flag. The data store may further be for storing, for each of the plurality of sellers, a seller grade dependent on at least one of a number of successfully completed transactions involving the seller and a number of disputed problem transactions involving the seller.

The buyer and investment interfaces are preferably implemented across the Internet.

The system may be for managing the purchase of services by buyers from sellers and the seller offer data for a seller may further include an availability record for the service offered for sale. The buyer interface is preferably implemented to: receive a purchase inquiry from a buyer, the purchase inquiry comprising a plurality of purchase criteria; output seller offer data for a plurality of sellers able to meet the purchase criteria; and receive the purchase request from the buyer accepting an offer, thereby creating the transaction.

Preferably, the investment interface is further implemented to receive monetary currency from the investor for the investment fund. Preferably, the investment interface is also further implemented to: provide the investment data for the investment fund to other investors; and receive monetary currency from one or more of the other investors for the investment fund.

Preferably, the data store is further for storing investment data comprising, for each of a plurality of investment funds, an investment fund identifier, the respective investment criteria, one or more investor identifiers and investor information including an amount of monetary currency received from each investor for the investment fund.

Preferably, the investment criteria for an investment fund comprise one or more of: a functional criterion defining the function of the monetary currency in the investment fund; an eligibility criterion defining potential recipients of the monetary currency in the investment fund; an allocation criterion defining how the monetary currency in the investment fund is to be allocated to recipients; a payback criterion defining how the recipients are to repay the monetary currency they receive; a spending criterion defining how the monetary currency in the investment fund is to be allocated to the recipients; and a penalty criterion defining penalties to be imposed on a recipient failing to meet payback criteria.

The investment criteria preferably comprise a functional criterion which is at least one of investment in a buyer or seller, lending to a buyer or seller or underwriting the transactions of a buyer or seller. The investment criteria preferably comprise an eligibility criterion which is at least one of a market limitation, a geographical limitation, a seller or buyer grade limitation, a maximum outstanding liabilities limitation and a minimum endorsing grade points limitation. The investment criteria preferably comprise an allocation criterion which comprises a payout limitation and an indication of whether and/or when repayment of monetary currency by the recipient is required. The investment criteria preferably comprise a payback criterion which comprises at least one of a fixed rate per unit of time repayment requirement, a floating rate per unit of time repayment requirement and a deduction from earnings requirement. The payback criterion preferably comprises a floating rate per unit of time repayment requirement, the floating rate to be determined by a falling price mechanism. The investment criteria preferably comprise a spending criterion which comprises at least one of a market limitation, a geographical limitation and a permissible sellers limitation. The investment criteria preferably comprise a penalty criterion which comprises at least one of a loss of recipient's grade penalty and a contractually enforced penalty. Preferably, the penalty criterion may further comprise a transfer to another investment fund penalty, non-compliance with a payback criterion to result in the transfer of the recipient's debt to another investment fund having a different payback criterion. Preferably, the penalty criterion may further comprise a loss of an endorser's grade penalty, non-compliance with a payback criterion to result in the loss of an endorser's grade, the endorser having endorsed the recipient.

Implementing the investment interface to provide the investment data to buyers and sellers able to meet the plurality of investment criteria for the investment fund preferably comprises implementing the investment interface to: receive an investment inquiry from a buyer or seller, the inquiry comprising a plurality of investment offer criteria; and output investment offer data for a plurality of investment funds able to meet the investment offer criteria. Preferably, the investment interface is further implemented to receive an investment request from the buyer or seller accepting an investment offer, thereby designating the buyer or seller as the recipient.

Preferably, the stored instructions further comprise instructions for controlling the processor, on acceptance of the investment request, to transfer monetary currency from an investment fund to the recipient.

Preferably, the investment interface is further implemented to receive an automated investment request from the buyer or seller, the automated investment request indicating acceptable investment offer criteria in respect of future transactions involving the buyer or seller.

Preferably, the stored instructions further comprise instructions for controlling the processor, on receipt of the automated investment request, to transfer monetary currency from an investment fund to a transaction involving the buyer or seller, the monetary currency being for financing or underwriting the transaction.

Preferably, the stored instructions further comprise instructions for controlling the processor to monitor compliance by the recipient with a payback criterion of the investment fund,

Preferably, the stored instructions further comprise instructions for controlling the processor, in the case of a payback criterion comprising a deduction from earnings requirement for a seller, to monitor for acceptable availability and pricing for the products and/or services of the seller.

Preferably, the investment interface is further implemented to provide investment performance data for a plurality of investment funds to investors, the investment performance data being presented in comparative form. Preferably, the investment interface is further implemented to provide utilisation data for the plurality of sectors or geographies of the market to investors, the utilisation data being presented in comparative form. Preferably, the investment interface is further implemented to provide investment opportunity data based on the investment performance data and utilisation data, the opportunity data indicating a plurality of investment opportunities and level of take up for each investment opportunity. Preferably, the stored instructions further comprise instructions for controlling the processor to automatically create investment funds having investment criteria based on at least one of the investment performance data, the utilisation data and the investment opportunity data.

The investment interface is preferably further implemented to: receive upper investment data from an investor, the upper investment data including a plurality of upper investment criteria for an upper investment fund, thereby creating an upper investment fund; receive monetary currency from at least one investor for the upper investment fund; and transfer monetary currency from the upper investment fund to at least one investment fund meeting the upper investment criteria for the upper investment fund.

Preferably, the stored instructions further comprise instructions for controlling the processor to manage a marketplace in positions in an investment fund, thereby allowing an investor to transfer a position in the investment fund to another investor.

Preferably, the functional criterion may further comprise underwriting the future price of transactions involving a buyer or seller.

An investment fund may be for payment of grants or welfare payments to buyers or sellers, payout of the grants or welfare payments depending on the conduct of the buyer or seller in the market, and payback of the grants or welfare payments not being required.

The stored instructions may further comprise instructions for controlling the processor to manage a banking service, the banking service facilitating the electronic transfer of monetary currency between investors, investment funds, buyers and sellers.

According to another aspect of the invention, there is provided a method for managing the purchase of products and/or services by buyers from sellers, the method comprising:
storing in a data store seller data comprising, for each of a plurality of sellers, a seller identifier and seller offer data indicating at least one product or service offered for sale;
implementing a buyer interface to receive a purchase request from a buyer based on the seller offer data, thereby creating a transaction; and
implementing an investment interface to:
   receive investment data from an investor, the investment data including a plurality of investment criteria for an investment fund, thereby creating the investment fund; and
   provide the investment data to buyers and sellers able to meet the plurality of investment criteria for the investment fund.

This aspect provides a method corresponding to operation of the transaction management system described above.

According to another aspect of the invention, there is provided an investment management system for managing investment in an underlying marketplace, the marketplace facilitating the purchase of products and/or services by buyers from sellers, the investment management system comprising:
a program store storing processor implementable instructions; and
a processor coupled to the data store and to the program store for implementing the stored instructions,
wherein the stored instructions comprise instructions for controlling the processor to implement an investment interface to:
   receive investment data from an investor, the investment data including a plurality of investment criteria for an investment fund, thereby creating the investment fund; and
   provide the investment data to buyers and sellers of the marketplace able to meet the plurality of investment criteria for the investment fund.

This aspect provides a standalone system that manages the investment functionality of the above transaction management system, and is for use with a transaction management system that manages transactions between buyers and sellers. The features described above that relate to investment management functionality are equally applicable to the investment management system.

According to another aspect of of invention, there is provided an investment management method for managing investment in an underlying marketplace, the marketplace facilitating the purchase of products and/or services by buyers from sellers, the investment management method comprising:
receiving investment data from an investor, the investment data including a plurality of investment criteria for an investment fund, thereby creating the investment fund; and
providing the investment data to buyers and sellers of the marketplace able to meet the plurality of investment criteria for the investment fund.

This aspect provides a method corresponding to operation of the investment management system described above.

The invention also provides a computer program arranged to cause a computer to execute the method described above and a computer readable recording medium having encoded thereon at least one program for performing the method described above.

A prior art system of multiple marketplaces such as that described in the background to the invention will contain many market inefficiencies. Examples include (a) sellers in one market, truck drivers for example, being in high demand while those in a similar market in the same area, taxi drivers perhaps, are in very low demand (b) types of sellers or types of transactions that are wrongly perceived as unreliable, for example it may be that buyers are reluctant to purchase house cleaning services because they believe cleaners Will steal personal possessions (c) qualified sellers who can not sell because they lack equipment required for the task, for instance, freelance television camera operators who do not have a camera of their own.

The present invention allows these inefficiencies to be resolved by turning them into investment opportunities. In the above examples it could allow investors to: (a) fund training for taxi drivers who wanted to convert to truck drivers in return for a percentage of their earnings in the more profitable market for a fixed period (b) underwrite the honesty of house cleaners in return for a charge built into each transaction (c) lend cash to qualified TV camera operators who needed to purchase their own equipment.

In making these investment decisions investors could have access to data about localised patterns of demand, supply and pricing in multiple sectors that was produced by the underlying marketplace. Additionally their investment needs to be controlled by the geography in which it applies and, if the underlying market graded its users according to reliability, investors should be able to limit their investment to recipients who had attained a certain level in the market which would be put at risk by defaulting on any commitments accompanying the cash provided.

Thus, the present invention creates the means for pools, or investment funds, of cash input by investors to interact with an underlying system of marketplaces. Each pool has a pre-determined purpose, target recipients, price construction formula and obligations placed on those who chose to accept its cash. Potential recipients are free to choose a pool that best meets their needs of the moment at the lowest rate. Any investor can create a pool which then automates (a) the allocation-of its cash to those who are eligible and willing to receive it, (b) enforcement of obligations, (c) dealing with defaulting recipients, (d) payback to investors and (e) reporting to investors. A range of universally applied metrics must allow investors to compare the performance of multiple pools each with their own functions, target recipients and payback periods.

The infrastructure described can also provide additional functions including: (a) automated creation of pools based on analysis of need in the underlying marketplace (b) upper pools which do not make investment directly with market users but move their investors' cash between the best performing pools that do interact directly with the market (c) awarding of grants to market users based on their location and market behaviour, for example charitable top up payments to users in depressed areas who consistently attempt to sell at a reasonable price but find no buyers or commercially motivated decisions to artificially lower prices in a particular market, perhaps to benefit subsidiary markets (d) a “street corner” banking service allowing interchange of physical and digital cash into the system that can be offered by any user.

Overall, the present invention makes the underlying market system more efficient and therefore more attractive to both buyers and sellers. It also creates exceptionally precise investment opportunities with the possibility of continuous innovation in investment opportunities by even the smallest investor.

The present invention provides for a computer server that sits alongside a system of marketplaces such as that described earlier. Said server administers a plurality of pools of cash that are held digitally. Said cash is taken from and paid into user's accounts by a payment transfer mechanism such as that described earlier.

Each pool is governed by a set of rules that dictate (a) the function it performs, said function being one of underwriting, lending or providing investment (b) to whom it will provide cash, this can be determined by geography, market grade and market or markets covered, for example “this pool provides money to anyone who has attained grade 4 or above in the secretarial market based within 5 miles of Central Boston” (c) for what the funds may be used, for example “cash is to be used only to purchase training from Acme Secretarial College” (d) the period by which cash must be returned (e) the rate to be charged; this can be fixed, or allowed to float according to demand (f) any obligations to be placed on recipients, for example “during the payback period the borrower must be available for work at least 30 hours a week within Central Boston” (g) any penalties to be inflicted on the recipient if they don't comply with the terms to which they have committed by accepting the cash.

Cash is awarded by the server to either (a) individual market users who can take out loans or accept an investment opportunity or (b) individual transactions which can be underwritten for a charge built into the price. Additionally, individual users can signify that they wish to accept loans built into the price of future transactions on occasions when they have insufficient funds to make a purchase.

Pools described thus far are deemed “lower pools”, they place cash directly in the underlying market. The present invention also provides for “upper pools”, that is pools of cash which arc invested, according to the creator's pre-determined parameters, in the best performing lower pools.

The specified server also performs tasks including the following (a) producing detailed information about the performance of each pool and its need for cash (b) analysing information about investment opportunities in the underlying marketplace (c) creating pools automatically when a clear gap exists (d) providing infrastructure for a rudimentary banking system in which users act as bankers in their locality. The server operating this combined system is designated “Pool Server”.

The invention disclosed creates a new channel for investment that creates opportunity in resolving inefficiencies that have historically been an inevitable part of all systems of marketplaces. It can deal in large or small sums with very low overheads and allows enormous precision in the risk/return payoff chosen by investors. Constant innovation is assured by the ability of any user to establish a new pool with a distinctive focus.

For the underlying marketplace, or multiple systems of marketplaces connected to the present invention, the present invention creates new opportunities and further incentives reliable behaviour by users. Anyone who rises up through the grades in any market, however lowly, can then find they are able to access very cost effective cash because they have established their desirability as a counterparty. This clearly benefits the market system as a whole.

### BRIEF DESCRIPTION OF THE DRAWINGS

FIG. 1 shows a completed buyer input screen within a known online marketplace defined by an ability to take in a buyer's requirements and immediately construct options specific to his needs based on broader inputs from any number of sellers

FIG. 2 illustrates an exemplary screen returned by such a marketplace in response to the buyer input in FIG. 1;

FIG. 3 is a schematic illustration of the communications links required for this known marketplace and which can form the basis of the system of the invention;

FIG. 4 represents the system architecture within the Application Processor 306 and Datastore 307 for the system of FIG. 3;

FIG. 5a illustrates the relationship of Pool Server and multiple investors' terminals to the underlying marketplace outlined in the previous drawings;

FIG. 5b shows the software modules and datastore within Pool Server;

FIGS. 6a and 6b show the screens offered to a system user who wishes to create a new pool;

FIG. 7a shows key elements in the record created within Pool Records Store 555 for each pool;

FIG. 7b represents key elements of the historic record of transfers into and out of each pool within Pool Records Store 555;

FIG. 7c illustrates key elements of the records stored within Investor Records Store 560;

FIG. 7d demonstrates key elements of the records stored within Recipient Records Store 565;

FIG. 8a illustrates the screen that would allow any user of the underlying market system to view pools which would currently be willing and able to make cash available to that user and the terms on which they would do so;

FIG. 8b represents the screen that allows any user to set the rules by which cash might be directed into future transactions in which they are involved;

FIG. 8c graphically illustrates the process followed by Transaction Handling Module 530 to inject cash-as-required into a transaction in the underlying system of markets;

FIG. 9a outlines the process used by Recipient Management Module 520 to ensure a user who has accepted cash from a pool is complying with the obligations to which they committed;

FIG. 9b outlines the process instigated if a user is not complying with the conditions to which they committed when accepting cash from a particular pool;

FIG. 10 represents the,basic graph output by a pool to report its performance to investors;

FIG. 11a shows the screen providing information to potential investors about patterns of utilization and pricing in a market in which they may chose to invest;

FIG. 11b shows the screen by which a user may search the underlying marketplace for peaks or troughs of utilization based either on sector or geography; and

FIG. 12 illustrates the screen used by an investor wishing to create an upper pool.

### DETAILED DESCRIPTION OF THE INVENTION

The following description envisages the technology required by the present invention as a separate server from that running the underlying market. It will be clear to those skilled in the art that the two could be combined within one processor and the following architecture is exemplary only. It is assumed cash is accessed and transferred via a value transfer methodology within the underlying marketplace, this would be Payment Transfer module 427 in the “GEMs” marketplace previously described as an example.

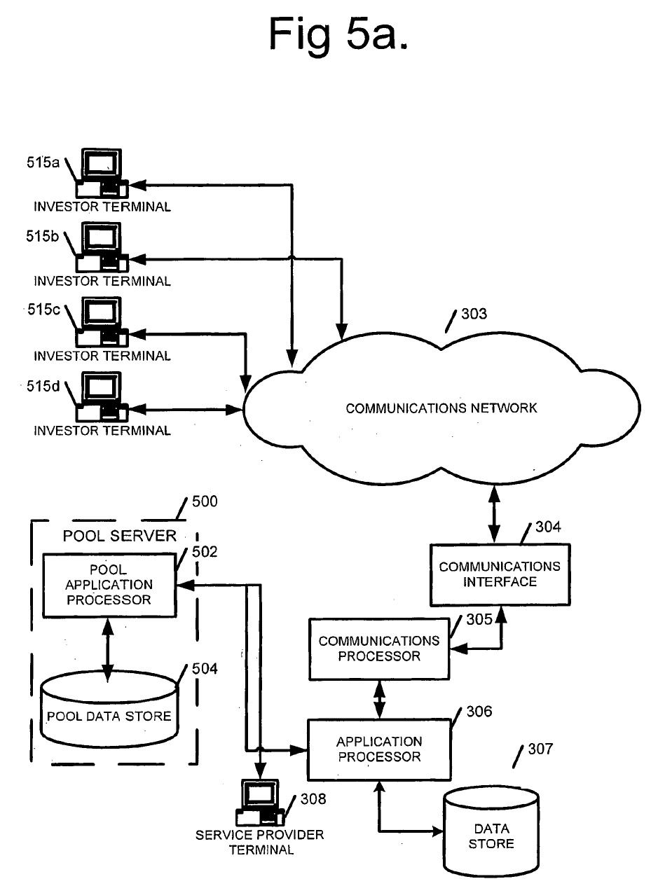

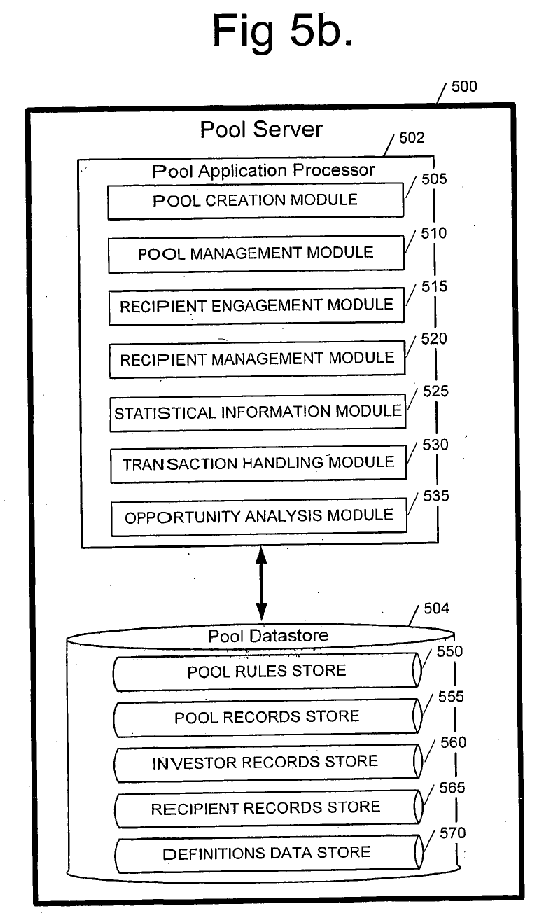

As shown in FIG. 5b. “Pools Server” 500 contains the following software modules and data stores, listed with an outline of their functionality:

505 Pool Creation Module allows any user to set up a pool with parameters that are not matched by one already in existence. In a further embodiment this module could automatically establish pools where patterns of demand and opportunity have been identified within the underlying markets.

510 Pool Management Module takes in cash from investors into a pool, manages the cash flow of each pool and produces information, including projected cash holdings and liabilities, about a pool on demand from users.

515 Recipient Engagement Module manages the process of listing pools available to a specific recipient; individual or transaction, and ranking them by value offered. In the case of upper pools this module searches lower pools and manages the upper pools interaction with them. It then facilitates allocation of cash.

520 Recipient Management Module ensures cash is spent by recipients according to the appropriate pool's rules and then monitors recipients for compliance with the rules of payback and compliance with obligations for any pool from which they have taken cash.

525 Statistical Information Module interrogates stored data about the performance of each pool to produce comparisons based on the inputs of a user wishing to compare pools.

530 Transaction Handling Module is triggered during the purchasing process in the underlying marketplace and can inject cash directly into a transaction with the previously given permission of either the buyer or seller.

535 Opportunity Analysis Module analyses both the underlying marketplace and the performance of pools to identify current opportunities for investment.

504 Pools Data store contains the following components:

550 Pool Rules Store lists the rules governing each pool against a unique identifying code for said pool. This information is generated by Pool Creation Module 505.

555 Pool Records Store stores the records created by Pool Management Module 510 including cash balances, spending allocations, payback records and investment records for each pool. Each pool has a digital account which stores cash currently belonging to the pool, all movements through that account—via Payment Transfer Module 427—are recorded on Pool Records Store 555.

560 Investor Records Store records all investors in Pool Server 500 and the amounts paid into each pool, the length of time for which their cash is to be held within-each pool and the returns accruing to individual investors. Investors may be users of the underlying marketplace, with identity already stored in Seller Database 431 or Buyer Database 432 within Price Construction Module 425 and cross referenced with a unique identity code to this datastore.

565 Recipient Records Store extends the record held in Seller Database 431 or Buyer Database 432 for any individual or entity on the system receiving cash from Pool Server 500. Against the unique identifying code for that trader it stores details of (a) amount of cash paid out and from which pool (b) date of payout (c) dates of payback (d) obligations as a result of accepting cash (e) controls over future payouts from Pool Server 500 as a result of outstanding commitments (f) willingness to receive cash-as-required as an integral part of transactions. This store also holds data about other users who will endorse an individual for the purposes of supporting their application for cash from Pool Server 500.

570 Definitions Data Store records information input through SPX governing the behaviour of Pool Server 500 in particular it contains the charging structure (percentage mark-up or per-transaction cost) that provides Market Operator's revenue and assumptions used as the basis for calculating utilization and likely utilization in markets or pools.

The processes required by the present invention will now be described in detail.

### Overview of the Pool System

FIG. 5a. shows how Pool Server 500 and a plurality of terminals used by investors, 515a to 515d, connects to the underlying marketplace already described. FIG. 5b illustrates the Application Modules and Datastores required within the Pool Server.

Pool Server 500 operates two types of pool. A lower pool is one that invests directly in traders or transactions in the underlying marketplace. An upper pool is one that moves its investors' money between lower pools. There can be an infinite number of either type, each defined by its unique record in Pool Rules Store 550. Lower pools will be described in detail first.

Lower pools are able to transfer cash either (a) to traders or (b) seamlessly into individual transactions with immediate impact on the unit price and liabilities of the user who authorised the cash injection. The later process will now be described in overview.

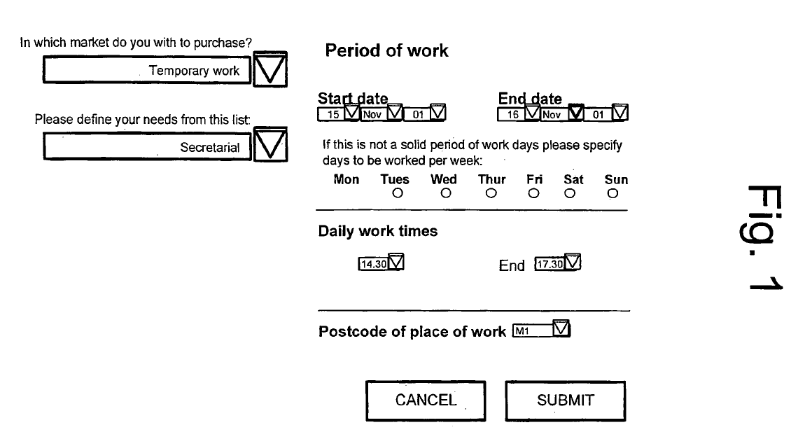

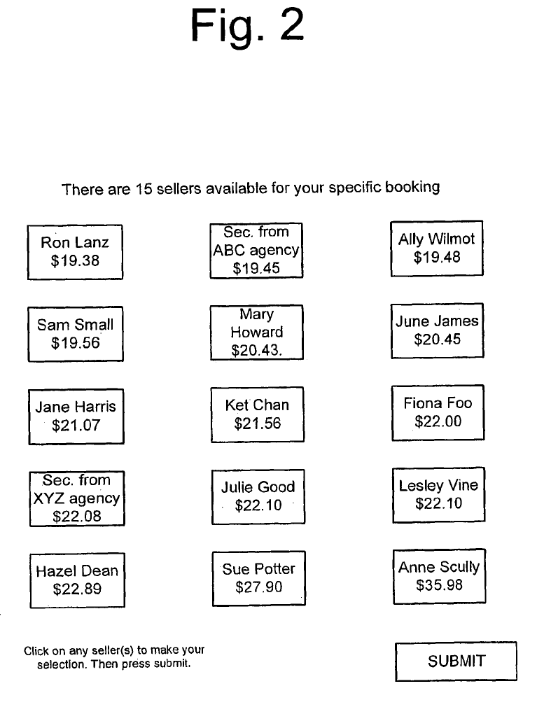

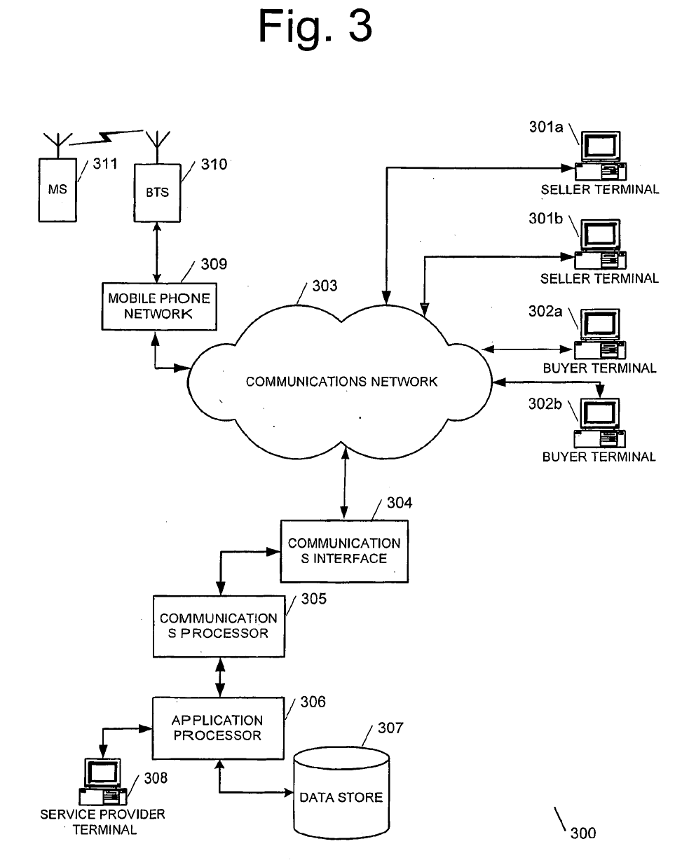

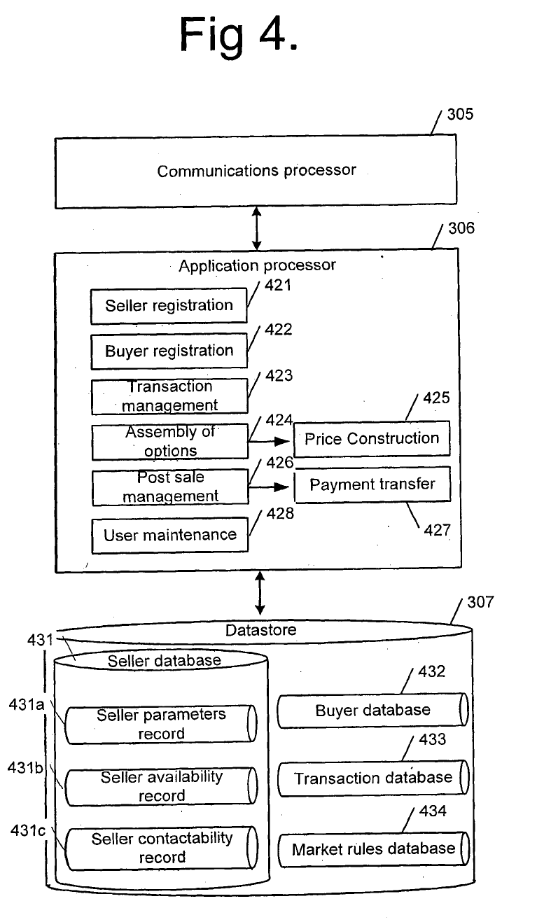

The involvement of a pool in an individual transaction can push the price either up or down. An example of a transaction in which the involvement of a pool raises the price will no-w be given. A pool might make loans available to individuals, with a particular profile of market activity, who have input purchase requirements using the screen shown illustratively in FIG. 1. which has produced returns, as shown in FIG. 2. some of which have a total price that exceeds the individual's current cash balance. The most appropriate pool might construct the rate at which a loan could be taken by that individual to enable each purchase option with the cost of the loan built into the price displayed.

An example of a transaction in which the pool is used to lower prices might be as follows. A promoter who wishes to attract older people to a seaside resort on a particular weekend establishes a pool to pay, perhaps, 20% of the price charged by any provider of overnight accommodation to any purchaser over 65 as long as (a) the maximum allocation of cash per purchase is not exceeded and (b) funds last. Said users see the lowered price displayed in the screen shown in FIG. 2. The rest of the seller's price is deducted seamlessly from the pool which does not demand payback or any contractual relationship with its recipients.

Lower pools can be broad in their scope or tightly defined. A broad loan pool for example might be one that tends up to $10,000 for any period not exceeding 365 days to any user. A very narrowly defined loan pool might be one that lends up to $100 to farmers above grade 5 within 10 miles of Malvern who need to hire an extra tractor for a day at harvest time but only if they hire from a named seller of agricultural equipment. A high grade farmer in Malvern who needs a tractor will be shown details of both pools, and others for which he qualifies, and can chose the one that best fits his needs. For small sums of cash, the decision can be automated; the system shops between relevant pools in search of the best deal for a particular transaction.

All pools are able to take cash in and pay cash out possibly using functionality in the underlying marketplace such as Payment Transfer Module 427 in the example already given. Thus, cash in a pool's account can be there after being transferred from (a) users (b) other pools. It can then be transferred to (a) users (b) other pools (c) the balance of payments for a transaction, that is supplementing the sum paid by the buyer to the seller so the purchase price is lowered.

### Creation of a Lower Pool

The creation of a pool will be detailed with particular reference to a pool focused on investing in specified market users. Details specific to pools that make loans and make cash available for underwriting transactions will be given later in this document.

An individual or institution wishing to create a pool must be registered on the system. They do this by default through Buyer Registration Module 422 unless they have previously registered as a market user through Seller Registration Module 421. Alternatively Pool Management Module 510 will allow them to register purely as an investor using a simplified form of the process required by Buyer Registration Module 422. The later process deposits full details of the new registrant in Investor Records Store 560, not just additional information against their unique identity code.

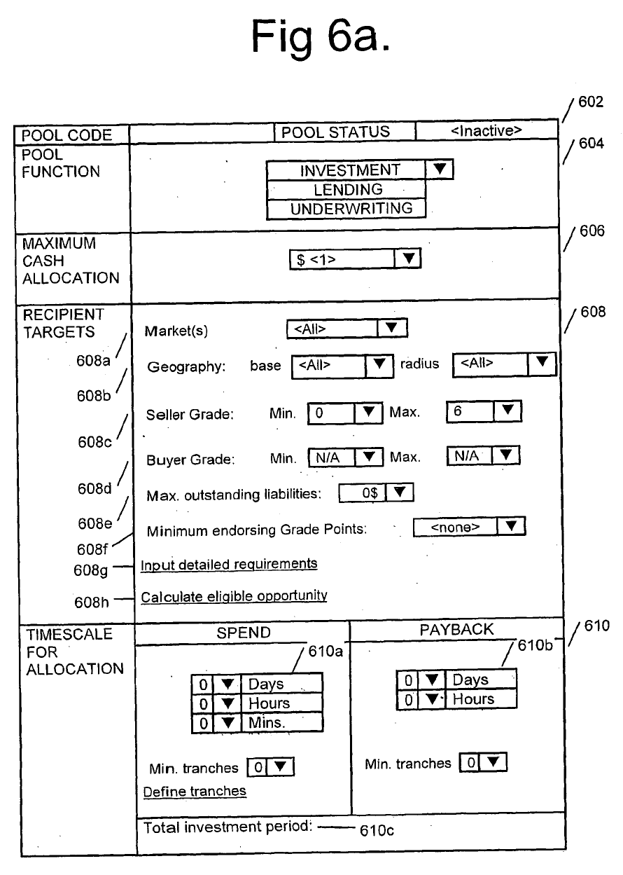

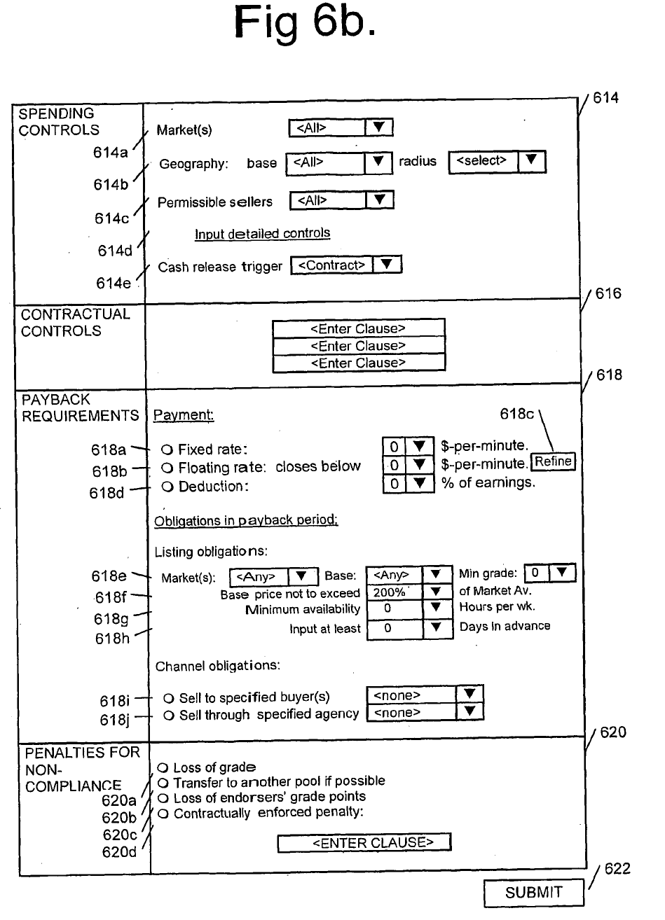

A user is able to access Pool Creation Module 505 having logged on to Pool Server 500. The information they must input if they wish to create a lower pool and define how cash is allocated is illustrated by reference to FIG. 6a and 6b. Once created, the pool will (a) make cash available to qualifying recipients who wish to accept its terms (b) accept cash from other investors who wish to invest in exactly the terms of this pool (c) report its position regarding cash and liabilities to any user at any time.

Pool Creation Module 505 offers the user a series of screens enabling a new record to be formed within Pool Records Store 555 and Pool Rules Store 550. Line 602 is populated with a code to identify the new pool, this is generated within Pool Creation Module 505. The module also assigns a status to the pool, either (a) “active” indicating it has funds to invest or (b) “inactive” signifying it has no cash to invest.

The creator's first action is to select the pool function within section 604. She must decide if the pool is for (a) investment—that is providing cash in return for a cut of each recipient's trading revenues thereafter (b) lending—that is providing cash which has to be repaid with interest (c) underwriting—that is providing cash that is earmarked for individual transactions (or a seller or a buyer to underwrite all transactions in which they are involved) and can be accessed by either party as compensation if the transaction fails. A giant giving pool can be based on any of the above, it performs the function but demands no payback.

At section 606 the user must decide the maximum cash allocation that the pool will make to any one trader or transaction. This will determine the risk it takes on any one transaction failing.

The user setting up the pool may specify who its recipients are to be, that is the parameters for market users who are allowed to access its funds. This is done at section 608. Line 608a allows the market(s) in which a recipient is active or in which a transaction takes place to be specified. At line 608b a geographic area within which qualifying users must be based, according to their record in Seller Database 431 or Buyer Database 432, can be defined first by inputting a postalcode which is converted to a map reference and then a distance around that postalcode. Thus the investor could specify she wants this pool to only be available to nurses within 10 miles of Central Birmingham. In a further embodiment lists of multiple geographic areas could be input.

At section 608c the creator can further narrow the focus of this pool, perhaps by stipulating only nurses who have attained at least grade 4 in terms of their numbers of bookings and reliability are to qualify. If the pool has been designated for underwriting earlier section 608d appears to ask for buyer grade parameters. For example the investor could input that this pool will under write transactions in the home storage market but only where the buyer is grade 3 or above; the higher the buyer's grade the less likely they are to willfully complain and cause the transaction to be classed as failed.

Many eligible recipients may have already taken cash from Pool Server 500 to further their career, borrow funds or underwrite their transactions. The creator may not wish to provide further money to these people until they clear their earlier liabilities. At section 608e she is therefore able to specify a limit on existing liabilities above which an otherwise qualifying recipient is ruled out. In an alternative embodiment this rule would be expressed as a percentage of recipient's turnover in any given period.

A graded market, such as the one that might underlie the present invention, contains many users who have accumulated a track record of reliable transactions. This might be expressed as a market grade. Such users may wish to endorse other users who they know to be reliable. For example a new user with a low grading might approach higher ranked users and ask if they will input their endorsement of the new user, they can do so having logged on and inputting the name of the new user with details deposited within Recipient Records Store 565.

By doing this they are undertaking that they will lose their grading on the system if the new user defaults on his obligations. Thus, the established users ale making a serious commitment to the reliability of the new user. The investor may wish to make funds available to these individuals knowing that, although they have little track record within the system, they will be under considerable pressure to comply with any commitments they make. These grade points can be numerical, in line with the grades. Thus a grade 6 user can bestow 6 grade points on any other user. Within line 608f the investor can opt to make the pool available to users who have accumulated, perhaps, 10 or more grade points that will be lost if they default.

An investor may wish to specify much more detailed parameters for recipients of cash from this pool. By clicking at line 608g she is able to move to a page which allows recipients to be selected by any detail about them that is stored-within Price Construction Module 425. Such details about a trader may include (a) age (b) length of time in a particular market (c) grading history (d) previous base postalcode (e) personal utilization: the proportion of units offered to units sold over a specified time frame (f) purchasing history in specified markets. Additionally, an investor may be able to name specific users to whom their investment exclusively applies, a benevolent parent investing in their children's training once certain conditions were met for example.

Means of further defining parameters of transactions might include (a) period of notice to purchase (b) time of day of booking (c) travel distance from seller base postalcode to place of delivery postalcode (d) time of year (e) frequency of transactions within a specified geographic area.

The ability to input detailed specifications of recipients are likely to be particularly useful where Pool Server 500 is being used to award grants from government or charities with no expectation of financial return. It enables a grant maker to intuitively create a pool for purposes such as “a grant for any 16-18 year old living in a defined area of social deprivation, who has attained at least Grade 4 in any market, to pay for up to $200 spending in the youth training marketplace”. They can then input a finite sum which the system will award according to their instructions.

By clicking at line 608h the investor triggers Recipient Engagement Module 515 to search Seller Database 431, Buyer Database 432 and Transaction Database 433 and return the number of qualifying transactions or traders within a given timeframe for the opportunity defined in section 608. The identities of potential recipients and individual transaction details are not revealed to an investor.

In section 610 the investment period time for the pool must be specified. This may have 2 stages (a) spend: the time in which a user who has accepted cash is allowed to spend it before beginning payback, this might also be controlled in terms of tranches with cash being released only once the recipient, or the trader with whom he spends the cash, confirms that a particular benchmark has been reached, levels in a training course for example (b) payback: the maximum timeframe in which the user can payback their obligations to the pool without incurring any penalties. Again, this can be split into a number of tranches, a number input in this box will be divided by the total payback time to produce a list of repayments and the dates/times they are due for each recipient. At 610c the three inputs are totaled by the system to show the time this pool will need to hold on to each dollar deposited.

The information now provided has enabled a functioning pool to be established. However, further details may be input to define the opportunity it is targeting and means of payback.

Turning to FIG. 6b which represents a continuation screen from FIG. 6a. The investor may wish to specify controls on how the cash passed to qualifying recipients is spent by those users. These controls can be either (a) automated controls enforced by the system because cash is drawn direct from the investor's account via Payment Transfer Module 427 and used for purchases within the underlying market system (b) contractual controls: the recipient must sign a contract on how the money will be spent but Payment Transfer Module 427 will transfer funds directly to the user's account from where they can be withdrawn from the system.

Automated controls can be specified at section 614. They may cover market sector(s) in which the funds can exclusively be spent, for example Childcare Training, as defined in line 614a. Again, the pool creator can specify at least one geographic area in which the seller from whom the recipient purchases must be based, using line 614b. For example, recipient nurses have to purchase Childcare Training within I mile of Central Birmingham. Additionally, at line 614c, the creator might wish to specify approved sellers with whom the funds must be spent by selecting from a list of sellers who meet the parameters defined so far in this section. Thus an investor might be investing to train nurses who wish to transfer to the childcare market in Birmingham but only if they train at the investor's own college, at which places can be bought in the underlying market system. Specified sellers are identified from Seller Database 431 and flagged on the pool's record within Pool Rules Store 550.

Line 614d allows the investor to input more detailed controls on how cash is to be allocated. This is particularly useful if the pool is to invest in individual transactions. More detailed automated controls might include (a) parameters of the purchase such as period-of-notice, total value or day of the week (b) details of what the spending must achieve, a price drop by a given percentage for example up to the maximum allocation figure (c) qualifying parameters for the seller of the goods or services being bought that might include grade, turnover, age, location or length of time in the market, said details are stored within Seller Database 431.

Line 614e allows the investor to stipulate what conditions have to be achieved before cash is released to the recipient. By default it releases cash once a qualified recipient has input their acceptance of a contract offered by Recipient Engagement Module 515 embedding all the conditions of the pool and permitting automated enforcement of controls and application of obligations. However, an investor may wish to demand additional compliance before release: in the case of training for example it could be that funds are not released until the recipient has proof of acceptance on an approved vocational scheme.

Section 616 allows the investor to create freetext entries that are added to the contract with each recipient. For example “the recipient agrees to study the works of Rudolph Steiner and list themselves as a Steiner child carer during the payback period”.

In underwriting pools these freetext clauses allow underwriting to be offered against specific eventualities. For example, an individual selling windsurfing lessons in the underlying marketplace could take out underwriting against the possibility lessons would have to be cancelled because of bad weather. To make a claim he would have to show (a) the lesson had been cancelled with the buyer's consent according to Transaction Database 433 (b) that he had proof bad weather was the cause, a link to the appropriate day's weather report online for example. He would then be reimbursed for the agreed cost of the lesson.

In a further embodiment Pool Server 500 might have a rule that any investor is entitled to check on the genuineness of claims resulting in lost assets over a certain period, perhaps the last ten weeks, providing said claims had not already been investigated under this rule. Any claims the investor believes to be unfounded can be forwarded to an arbitrator at the investor's cost, if the claim is then ruled unproven or otherwise in breach of contract, the recipient will be downgraded. The amount owed can be transformed into a loan automatically by Recipient Engagement Module 515 and the assets recovered immediately with the investor and the pool splitting the proceeds perhaps on a percentage basis determined competitively among investors who wish to provide this service. Thus, there is an automatic debt recovery for pools based on freetext clauses built into Pool Server 500. In an alternative embodiment of the present invention the creator of a pool would be able to specify that claims for underwriting payouts based on freetext clauses were checked by an independent arbitrator.

At section 618 the terms on which the pool will make its return from each recipient are input. These can comprise either or both of (a) a repayment formula (b) market behaviour required during the payback period. The later is particularly relevant if the pool is placing investments in users in return for a cut of their earnings during the payback period.

There may be three options for re-payment of which only one can be selected. To enable (a) accurate charging in fast moving markets (b) like-for-like comparisons between multiple pools with varying functions and investment period times, the charging metric used by Pool Server 500 is dollar (or other currency unit) per minute. That is, the pool charges a sum for every minute a dollar is taken out of the pool but has not been repaid by its recipient. This can be converted to a percentage rate for display to users. For example, a dollar-per-minute rate of $0.0000001 (0.00001 cents) equates to non-compounding interest of approximately 0.014% of the capital a day, 0.1% a week or 5.26% a year.

Line 618a allows the investor to set a fixed rate at which this pool will provide cash, subject to its conditions, to qualifying recipients. This can be input as a dollar-per-minute rate or, in an alternative embodiment, as a percentage defined by the timespan of the users choosing, said figure being converted back to $-per-minute for storage in Pool Records Store 555.

Section 618b allows the investor to specify that the rate charged by the pool will float in line with demand from recipients and the willingness of investors to input cash. There are many ways by which this could be achieved that will be known to those in the art, they include Continuous Double Auctions and matched bid/ask offers. A further alternative which (a) allows a newly launched Pool to find a price level with no history of transactions and (b) proactively creates an offer price so recipients do not have to work out what the funds are worth and make bids, is a falling price mechanism that will now be briefly explained.

The pool starts with a default dollar-per-minute price that is, perhaps, 110% of the current highest performing pool within Pool Server 500, the multiplying factor being stored in Definitions Data Store 570. The price then falls at a rate, again determined by rules within Definitions Data Store 570, that might dictate it falls towards 90% of the dollar-per-minute rate for the worst performing active pool currently within Pool Server 500 and that it does so in the time projected from historical data for 250 eligible transactions to occur. An eligible transaction is an enquiry, resulting in a transaction, through Recipient Engagement Module 515 by any recipient who would be qualified to draw on the pool in question.

Once a first recipient accepts cash from the pool a price is established. To enable upward price movement as well as downward the offer price after a purchase “bounces” upwards in increments until it has gained perhaps 10%, reaching that point within the time projected for, perhaps, 10 eligible transactions to occur. If there is no further purchase by the time a 0.1% lift on the last established price is reached the offer price falls again within the same timeframe until the last purchase price is reached when the fall rate set earlier is resumed until another purchase occurs. In a further refinement: in a pool with large cash reserves (a) the “bounce” should be lower (b) the number of eligible transactions before it is reached should be less. This reflects a need to keep downward pressure on offer prices-because of a high supply of cash to be placed. If the pool runs out of cash the process of setting a price starts afresh.

By clicking on line 618c the investor is able to change the following parameters of the mechanism just described: (a) the start rate from which the opening price will fall (b) the low point towards which it will fall (c) the rate of fall (d) the height of “bounce” after a purchase (e) the time taken to reach the height of the “bounce” from the last purchase price.

In a further embodiment, the pool creator may be able to set a tracking price. That is, the price in the new pool will remain at a selected rate above or below a known index figure. Said figure could be (a) input through Definitions Data Store 570, for example the national base interest rate in the country of operation, or (b) calculated based on constant parameters applied to performance of pools within the present invention.

The method just outlined incentivizes early recipients of an otherwise unused pool with only a little cash because the price will begin to rise after the first recipient. If recipients are in quick succession the price will rise progressively after each, thereby dampening demand for a period. This is desirable in investment pools where there is a danger of the opportunity in which the pool is investing becoming flooded with recipients. For example, it is not desirable for hundreds of nurses in Birmingham to commit to switching to selling in the Home Childcare market however great the need in that market at the time the investment was initiated. However the mechanism just outlined may be unsuitable for pools in which there is nothing to be gained by slowing demand, such as loans, where other mechanisms for setting a floating rate could be adopted.

A user selecting the floating rate option is able to specify a price point at which the pool stops investing. For example: if the rate falls to 0.0000008 c for a dollar-per-minute the offer price will stay at that rate and not fail any further.

The third method of repayment, selected at line 618d, is to specify a percentage of each recipient's earnings within the underlying market that will be deducted by Payment Transfer Module 427 and paid directly back to the pool for the duration of the payback period. (In a further embodiment the percentage charge could be pro-rata to the percentage of Maximum Cash Allocation required by a recipient. This incentivizes the recipient to keep-spending to a minimum.) This allows investors to take on the risk of enabling new market activity. For example a pool could be established for individual catering providers who wish to purchase additional equipment for their kitchen so they can provide for larger events.

It is undesirable that a recipient who for example accepts training as a plumber on a basis of profits from the new market activity shared with an investor, then fails to sell their services having trained. Deduction repayment can therefore be accompanied by controls on the recipient's market behaviour throughout the payback period. Recipient Management Module 520 will ensure these conditions are met. In a preferred embodiment payment by deduction is not made available for underwriting pools because the charges those pools make can be so small. A few cents in each transaction in the case of some markets, that it would be unduly onerous for recipients to then be subjected to listings requirements for sums which are better built into the price of each transaction at whatever $-per-minute rate the pool creator wishes.

At line 618c it can be stipulated that recipients must sell their services exclusively in the market(s) selected by the investor and they must do it from a base postalcode/map reference. It might also be specified that they are in breach of their obligations to the pool if they fall below a certain grade in the market, for example by allowing their transactions to fail.

To avoid recipients effectively ruling themselves out of work by inputting unrealistically high pricing the investor can input, at line 618f, that the recipient must not charge more than a chosen percentage of the current average unit price for that market in that area as stored in Transaction Database 433. At line 618g the investor can stipulate that the user must be available to sell services for a minimum number of hours per week of the payback period.

At line 618h it can be specified how far in advance availability will be offered. A default period might be that the availability for any given week must be input at least a week ahead. Recipient Management Module 520 will monitor each recipient for compliance.

An investor may have an agenda other than straightforward return on their cash, It may be that an employer or agency wishes to invest in increasing the skills of their local workforce through the system for example and may wish to then monopolise the benefits of doing so during the payback period. This can be achieved through line 618i where the availability and pricing obligations above can be confined to offers to a particular buyer or number of buyers in the market. Said buyer(s) are identified with their unique identifying code held within Buyer Database 432. In a further embodiment, this rule may be softened to specify the named buyer(s) have priority until perhaps 48 hours of the period of work when the recipient is open to all buyers. Likewise at line 618j it can be mandated that recipients have to enter the system of markets through a particular agency that is active on the system. In the case of underwriting pools or loans pools which may put cash into transactions, lines 618i and 618j will ensure cash only goes into transactions involving the listed parties as buyer, seller or middleman.

Finally, Pool Rules Store 550 needs a record for the sanctions to be imposed on any recipient who signs up to the conditions of the pool, withdraws the cash, but then fails to comply with their obligations. This is defined at section 620 where any number of options can be selected. Line 620a allows for the recipient to automatically lose their market grading and be sent to Entry Level or suffer a pro-rata penalty based on (a) percentage of payback on which they defaulted (b) their current grade. Line 620b allows that in the event of non-compliance the pool may effectively transfer their debt to another pool which may have more arduous obligations. (To maintain faith in the investment system among recipients, Definitions Data Store 570 may contain rules limiting such transfers stipulating, for example, that payback periods and amounts may be extended by no more than 200%.)

Line 620c ensures the number of grade points pledged by users supporting the failed user must be forfeited. User Maintenance Module 428 takes them—as far as possible—in proportion, but otherwise randomly from those on the list of endorsers stored in Recipient Records Store 565. Thus users are constantly reminded that endorsing new users, and creating trust for investors, is not to be done lightly.

Line 620d allows the investor to input a contractual obligation in freetext form that will appear on the contract with recipients. It will be made clear to investors at this stage that any obligations outside the law of the country of operation are unenforceable.

Once the creator clicks on submit button 622, Pool Creation Module 505 confirms (a) that sufficient information has been given to create a viable pool (b) that Pool Rules Store 550 does not contain any pool with identical rules to the one just created. Clearly it can not meaningfully compare freetext entries but, if a pool already exists with all the same drop down box selections the creator is asked to confirm that any freetext entries are different in meaning from those already on the database. Alternatively, pools with freetext clauses may have to be vetted by a human operator before being allowed active status.

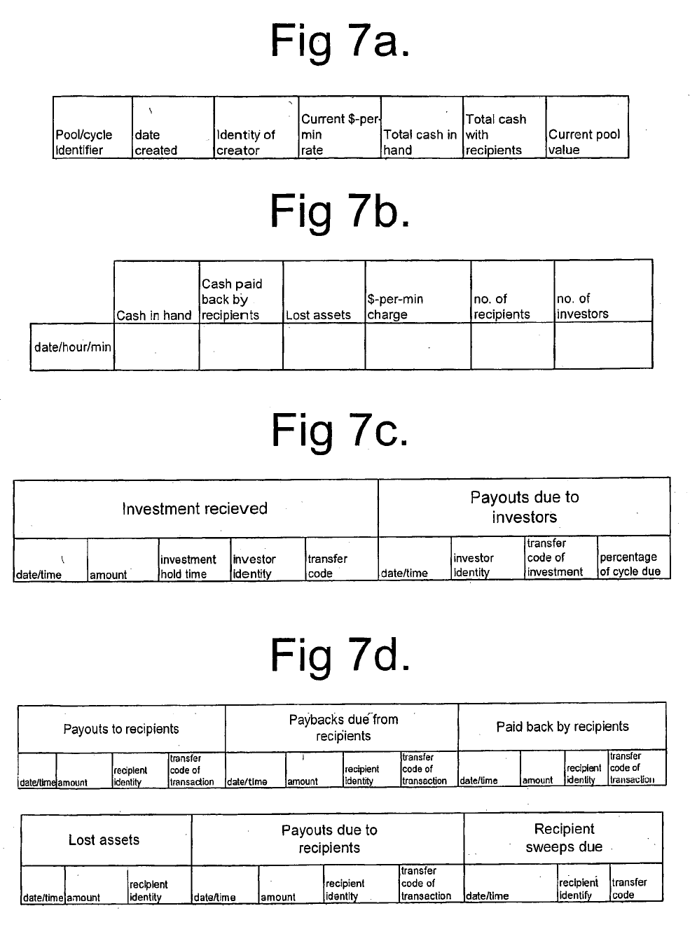

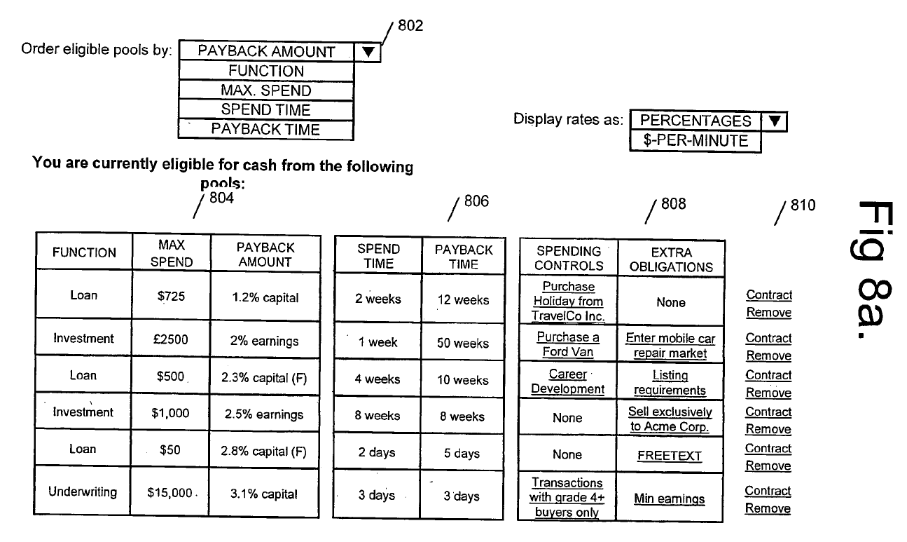

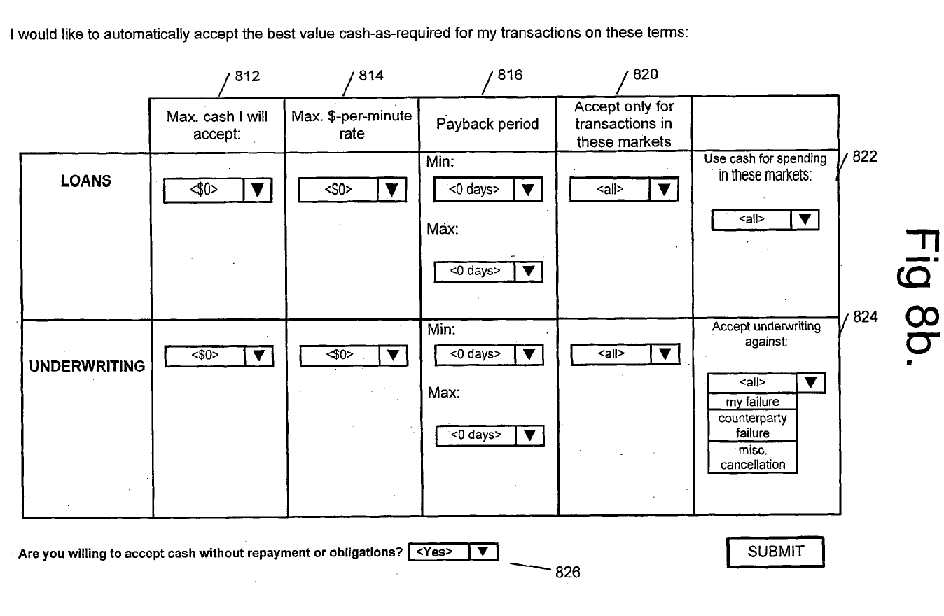

Assuming the new pool is unique the following happens: (a) the rules, as outlined in the foregoing screens, are deposited in a record against the pool identifying code within Pool Rules Store 550 (b) a blank record of the pool's pricing and current cash position is established within Pool Records Store 555 as illustrated in FIG. 7a. (c) a blank historic data record for the pool is established within Pool Records Store 555 as illustrated in FIG. 7b. (d) a blank record of investor activity for this pool is created within Investor Records Store 560, said record being illustrated by way of example in FIG. 7c. (e) a blank record of payouts to and sums received from recipients is created within Recipient Records Store 565, said record being shown illustratively in FIG. 7d. (f) a digital account for the new pool is opened which Payment Transfer Module 427 can transfer cash into and out of. Additionally it is possible the market operator will charge a fee for establishing a pool, said fee recorded in Definitions Data Store 570 and deducted from the creator's account by Payment Transfer Module 427.

It should now be clear that the investor has created a new pool which is defined in its purpose, targets and demands within Pool Rules Store 550 with dedicated space in Pool Records Store 555 available to record any activity. The pool is defined by common parameters but could have an infinite range of functions and controls. Further examples of pools, without limitation, include: (a) a pool for lending anyone who has attained Grade 6 in a hospitality market up to $5,000 dollars for up to 12 weeks to be spent on whatever they wish so long as it with a trader turning over less than $50,000 a year on the system (b) a pool to provide underwriting for transactions, above Grade 5 level for both buyer and seller, in the home security warden market where the buyer is willing to pay a premium, built into his purchase price, for up to $10,000 insurance to cover his home contents for the period the warden is in charge of his home (c) a pool to provide up to $100,000 for upgrading of equipment for any seller of any grade in the “entertainment venue” market in outer London with legal controls built into the freetext contract clauses (d) a not-for-profit pool that pays part of the costs of any transaction involving a worker from a deprived area travelling to the nearby city for short notice work (c) a pool that seamlessly allows high grade users with a pattern of regular income to make a purchase that exceeds the amount currently in their account using a loan that is automatically priced into the purchase price calculated by Price Construction Module 425 (f) a pool that insures remote call centre agents selling their services to a variety of call centres through the underlying marketplace; the pool provides additional underwriting to enable replacement if an agent is not available at the time contracted.

### Investing in a Pool

Creating a pool and investing in that pool are two separate processes, it is possible to create a pool then leave it empty to potentially attract other investors. In an alternative embodiment a creator would be able to create a closed pool that only they could access, or charge others to do so, and chose to not have its performance reported to any other user. This would incentivize innovation in pools but also encourage users to create multiple pools with meaningless, and therefore confusing, freetext entries so they appeared to be different from a closed pool believed to be doing well.

A pool can not simply be one lump sum of cash with ever changing investors coming in and out and owning a relative percentage of the pool at any time. That would allow investors to distort the percentage they own with cash movements ahead of payout times. Instead, each pool operates as a number of self contained cycles. Each cycle is a period of time in which said cycle (a) takes in cash from investors in the pool (b) pays cash out to recipients (c) collects the return from recipients (d) disburses the capital and profit accrued to investors, in proportion to the percentage of total they paid in at the beginning of the cycle, at or before the payback time.

The length of cycle for most pools could be 24 hours with as many cycles required as there are days in the investment period. Thus a pool that has an investment period of ten days is actually divided into ten cycles, possibly with a changeover period at midnight. Thus money invested on the 14^{th} of April is withdrawn by recipients on the 14^{th} of April and the cycle then closes because new investors and recipients will interact in the next cycle on the 15^{th}. Surplus cash in one cycle can be moved into the next cycle if the investor has specified they are willing to wait another day for their payback. Pools with investment periods below 3 days will probably merit cycles of an hour. For statistical outputs the dealings of all cycles in a specified pool are merged.

Putting funds into a pool is achieved through a screen, generated by Pool Management Module 510, that summarizes the key rules of the pool and invites the viewer to transfer their chosen sum for the duration of the Pool Investment Period. That process is accomplished by Payment Transfer Module 427 which takes stored value from the user's account and transfers it into the pool's account. Each of these transfers is given a transfer code to distinguish between possibly multiple transfers into one cycle by an investor.

Additionally the user may be able to stipulate that their cash is only to stay in the pool for a period of, perhaps, 12 hours. If it has not been all or partially allocated to recipients in that time it is to be all or partially returned. This is known as the “investment hold time” and might be calculated using a “bottom of the pile” method: each investor's dollars are added to the top of a metaphorical “pile” of cash available to recipients who are allocated dollars from the bottom. If the individual investor's dollars remain unallocated at the given time they are taken out of the pile and those above drop down the stack to replace them. Investors are able to access all details about their activities held within Investor Records Store 560 illustrated in FIG. 7c. through a “my investments” page.

### Recipients Select Pools

Any user with access to Pool Server 500 can instruct Recipient Engagement Module 515 to display a list of pools from which that user is qualified to draw funds. This is produced by searching Pool Rules Store 550 for all pools that meet the following requirements: (a) the user is active in the market defined at line 608a; that is a percentage of their grading in the system—as stored in Definitions Data Store 570—was attained by activity in the given market or markets (b) the user's base postalcode is within the geography defined within line 608b (c) the user's grade as a buyer or seller is within the range set out in lines 608c and (d) a search of Recipient Records Store 565 shows the user does not already have liabilities to Pool Server 500 of or above the figure input for this pool at line 608e (f) the user has an endorsement equalling grade points of or above any specified in line 608g (g) the user meets any additional requirements input at line 608g. Pool Records Store 555 is then searched to confirm each pool has cash to invest, those that don't are excluded.

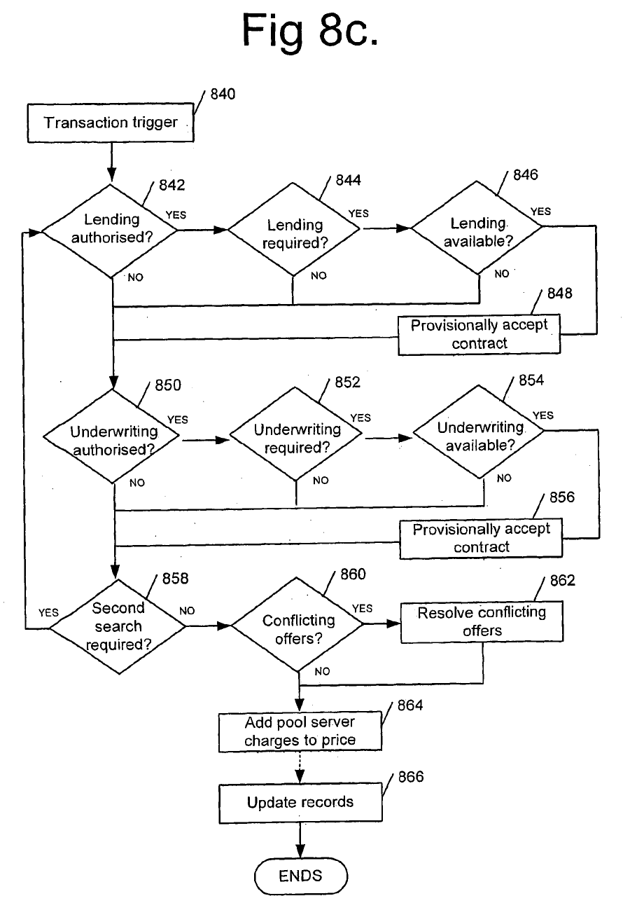

An exemplary illustration of the resulting screen is shown in FIG. 8a. This screen will now be described.

Line 802 allows the user to specify how they want the list of pools for which they qualify ranked. Section 804 lists the basic details of each pool. The Payback Amount column is displaying current rates for floating price pools among fixed price pools, the (F) indicates a pool rate is floating and is likely to change. Section 806 displays the timespan of each pool for comparison. Details of accompanying controls and obligations, if any, can be found by clicking on the appropriate entry in section 808.

Selecting “contract” with reference to any particular pool in section 810 takes the user through to a screen showing full details of the selected pool. Said screen will be similar to those illustrated in FIGS. 6a and 6b, with sub screens as required for more detailed information, but will displaying outputs only with no facility to change the rules of the pool. The screen ends with an “accept cash” button, a box in which any amount up to the Maximum Cash Allocation can be input and a means of signing an online contract as will be familiar to those in the art. If additional requirements have been specified before the cash release can be triggered the contract will demand proof that they have been complied with, for example by the input of a known authorisation code from a place of learning. Selecting “Remove” within Section 810 signifies that a potential recipient is not interested in that pool and wants it removed from future display of this screen.

As an alternative means of accessing the information more precisely, a user can use an alternative screen to input (a) the amount of cash they require (b) for what function it will be used (c) optionally, in which market sector(s) it will be spent (d) optionally, for how long they require the cash and the system will return the best value option for that need. In a further embodiment, a user can “click to remove pools with freetext contracts” or “click to remove pools with controls and obligations” to create a view of standardised options within which pools can be selected simply on price.

Once an eligible user has accepted cash the following events are instigated by Recipient Engagement Module 515: (a) Payment Transfer Module 427 moves the sum input to the user's account, If the pool's spending controls at section 614 stipulate the sum be spent in certain markets, with sellers whose base postalcode is within a given geography or with named sellers, the stored value comes in the form of “electronic vouchers” which are only redeemable for purchases meeting all those requirements (b) Recipient Records Store 565 is updated and will include dates/times when obligations or payback tranches are due, these are trigger points for Recipient Management Module 520 to check compliance (c) Recipient Management Module 520 is triggered to begin monitoring of the recipient's activity to ensure it complies with any instructions input in section 618 and that the amount is repaid within the payback time (d) records such as pool cash-in-hand, amount invested, dates of due payback and number of recipients are updated for the appropriate pool within Pool Records Store 555 (e) a “my liabilities” page within a “my accounts” section for the recipient is updated (f) a record on Seller Database 431 or Buyer Database 432 as appropriate that records the most restrictive liability limit among pools to which the recipient has liabilities is updated if necessary. The later ensures the user is not able to take on new liabilities from Pool Server 500 that would breach the terms of existing liabilities.

The process just described allows a recipient to draw down a sum of cash, or online vouchers, ahead of their need for that cash. Pool Server 500 also allows cash to be inserted into a transaction at the point of need, this makes use of cash considerably more efficient for buyers and sellers. This facility for cash-as-required is available providing the following conditions are met: (a) the transaction meets all the requirements stored in Pool Rules Store 550 as input through section 608 for one or more pools (b) the buyer or seller have authorised cash-as-required and will accept the accompanying liabilities.

It is unlikely there would be demand for an investment function within transactions. However, both loans and underwriting functions are valuable on an individual purchase basis. A loan might be used when by a buyer when (a) they don't have sufficient funds in their account for a purchase and (b) there is a pool willing to lend them the required cash. In this situation the amount required would be taken from the best value pool willing to lend to that buyer with the charges built into the price for that purchase. Likewise, a seller may require a loan at the point where their services are bought, for example to cover the cost of hiring equipment they will need to complete the transaction before they are paid. Their price for that particular transaction can therefore include the cost of a loan that is effectively factoring the seller's costs.

It has already been disclosed how an underlying “GEMs” type market may underwrite transactions, that is hold a sum of cash against each one that can be accessed to fund a replacement provider if the seller fails to deliver. This facility can be supplemented or replaced by Pool Server 500. In these circumstances a buyer's requirements are input through the screen shown in FIG. 1, an Underwriting Module decides for which available sellers underwriting is applicable and then seeks to compare costs of underwriting each of those sellers in search of the best value option. To do that an Underwriting Module assembles information including (a) market in which transaction is taking place (b) grade of buyer (c).grade of seller (d) purchase price of seller's option for this buyer. This can then be used to produce a ranking of pools that will provide underwriting for this transaction from Pool Rules Store 550 and the current price of each from Pool Records Store 555. If a pool provides a better rate than the Underwriting Module then that cash may be accessed.

Cash for underwriting is provided for a fixed term as demanded by the Underwriting Module. For example, the hire of a Grade 6 taxi in the underlying marketplace may require underwriting cover up to $100 with closure 8 hours later. That is, if no complaint has been made to the system within 8 hours of the transaction completing it is deemed to have completed successfully and no claims for compensation will now be entertained. Thus this transaction could draw on funds from any underwriting pool whose record in Pool Rules Store 550 included (a) the taxi journey market (b) grade 6 sellers (c) the grade of the buyer (d) a maximum cash allocation of $100 or more (e) a payback period of at least 8 hours. Once taken, the $100 is held in a separate holding account from which it is paid back to the pool after 8 hours unless it is frozen because a complaint about the transaction has been initiated. Frozen cash is counted as lost assets, it may be paid back at some future point; if so it is used-to redeem lost assets at that time in the pool from which it came. The $-per-minute charge for the money is added to the cost of the transaction.

In a further embodiment a holding account that is unable to repay cash because it has been frozen may seek a pool that is willing and has cash available to take on the debt. Such pools are likely to be run by debt collecting firms and contain onerous freetext clauses. It may be that, in the interests of protecting recipients, Definitions Data Store 570 does not permit transfer of underwriting lost assets for this reason.

The screen through which a user can input the authorisation required is shown in FIG. 5b. Section 812 allows the user to define the limits of cash he will allow to be automatically inserted into his transactions with 814 and 816 further narrowing the parameters of permissible involvement by Pool Server 500. At column 820 he may restrict the market sectors in which he is willing to accept pool cash and its accompanying liabilities. Section 822 allows him to specify the markets in which loan cash will be spent and may increase the number of eligible pools and thereby enable a more attractive rate. For example he may specify that for any sale in the “plumbing services” market he only requires a loan to spend in the “plumbing equipment” sector. Section 824 allows the underwriting to be limited to any combination of (a) seller failure (b) buyer failure (c) failure due to external circumstances. Line 826 allows a user to stipulate that they are happy to accept cash offered to lower the price of their transactions if it comes with no demand for payback and no obligations of any sort. Said cash is likely to come from pools set up to promote certain types of market behaviour, for example a promoter who wishes to encourage coach journeys to a particular destination-at a given time. Clearly cash from these pools will appear at the top of any ranking of best value cash-as-required for this transaction and may be the only pools a user is willing to involve in their transactions; The updated inputs for a particular user are stored in Recipient Records Store 565.

Once cash is drawn as part of a transaction all records are updated in the way outlined above. A transaction can create both kinds of liabilities, loan and underwriting, for both buyer and seller. For example in the purchase of a plumber to clear a blocked drain, the seller might have underwriting against the possibility of damage caused by professional incompetence and require a loan to be spent in the tools market to enable the hire of a set of tools. Similarly the buyer may need a loan to purchase the plumber's services until his next payday and be purchasing a high graded plumber who carries underwriting against failure to turn up on time. Each of these four components can be built into the price charged to the buyer for this particular seller in this particular transaction. The resulting liabilities will be dispersed to the appropriate account, either buyer or seller, until they are paid back.

When a contract is signed with a pool the recipient has to be allowed a hold time of perhaps 2 minutes, that is a period during which they can cancel the arrangement. This is particularly important for automated applications on a transaction by transaction basis where loans or underwriting for multiple seller options may need to be constructed with no guarantee any of those options will be purchased. The market operator may impose a charge on funds as they go across to a recipient.

### Automated Recipient Interaction with a Pool

The process of searching pools and accepting cash from the one offering the best value is automated in the case of cash injected into transactions. Transaction Handling Module 530 is triggered every time a transaction occurs in the underlying marketplace. The process it follows is outlined in FIG. 8c and assumes the underlying marketplace is a “GEMs” type market as outlined earlier in this document.

The process illustrated is triggered once (a) a transaction has been instigated within Assembly of Options Module 424 which is searching for sellers able and willing to deliver the goods or service required for the buyer's needs then constructing a price for each (b) either the buyer or one of the available sellers has a record stored in Recipient Records Store 565 showing they will accept cash-as-required, if not the transaction continues without the involvement of the present invention. If they have the process is triggered at step 840 starting with a search on the needs of one party. By way of example, this illustration assumes both parties have recorded their willingness to accept cash-as-required. The search starts with the requirements of the buyer.

At step 842 the record in Recipient Records Store 565 is checked to see if the seller will accept loans as part of having their services or goods purchased. At step 844, Transaction Handling Module 530 assesses if cash is required as a loan by the seller to complete this particular transaction: that is, have they specified they need a loan as part of each transaction in this market either in cash or as vouchers to spend in their specified market? If so, the parameters of the transaction are used to search Pool Rules Store 550 for applicable pools then Pool Records Store 555 for the current offer rate of those pools at step 846 with, at step 848, a contract for the maximum amount of cash previously specified by the user is provisionally accepted and the information temporarily stored. If the only money available exceeds the limits input by this user in the screen shown in FIG. 8b it is assumed no lending is available at step 846.

At step 850 the seller's requirements within Recipient Records Store 565 are assessed to see if they require additional underwriting for a transaction with these parameters. If so, steps 852, 854 and 856 replicate those above.

At step 858 Transaction Handling Module 530 checks if the second party in the transaction is also registered on Recipient Records Store 565 as willing to take cash-as-required. If so the process above is repeated for the buyer. In this case for loans it compares his personal account details in Buyer Database 432 with the prices of each individual seller and inserts cash from the best value of the eligible pools.

It will be appreciated that there may be four or more provisional contracts in place at this point. At step 860 the process checks for any conflicts between them. Said conflicts might include for example a loans and underwriting for the buyer on this transaction which when combined push him over the acceptable liabilities for one of them. Any conflicting offers are resolved at step 862 firstly by searching for a replacement pool which allows higher outstanding liabilities and if that fails by removing firstly the lowest value of the conflicting offers. It should be clarified that both parties may have underwriting on, for instance, seller failure because it is mandatory for the seller because of their grade and optional for the buyer. If that eventuality happens the buyer can then be compensated with the payout of both. Additionally, it is possible both parcels of cash for underwriting will have come from the same pool if it represents the best value for each user independently. In a further embodiment of the present invention, pool creators could avoid this double exposure to one transaction by selecting “underwrite sellers only” or “underwrite buyers only” within section 608 of the screen illustrated by FIG. 6a.

At step 864 the combined $-per-minute charges for each seller offer are confirmed, totaled and built into the price assembled by Price Construction Module 425 for that option. Options that were not selected for purchase are cancelled or allowed to lapse. For any option then purchased by a buyer at step 866 all records are updated and any appropriate messages generated through Communications Processor 305. For example, a seller may receive a message alongside their notification of the purchase that “you have up to $200 to spend on the equipment required before mid-day next Tuesday”.

In a further embodiment of the underwriting function the system itself may unilaterally enter the underwriting market for each transaction to see if it is possible to find a better rate than its own Underwriting Module will offer for each seller to be underwritten.

In a preferred embodiment, pools with freetext contractual clauses are excluded from automated cash acceptance by recipients. An alternative would be that if said pools offer the best value for a transaction the freetext clauses are displayed to the recipient for online acceptance before a transaction can complete. Clearly there can be no automated acceptance of freetext contractual obligations not read by a user.

### Payments in to a Pool from a Recipient

Payback into pools can come from two sources: (a) cash that has been transferred to a holding account to be accessed in the case of an eventuality, that has not happened and the cash is being returned (b) from users who have been recipients of cash earlier. Recipient paybacks can be either (a) a sum fixed at the point of contract to be paid across by the recipient (b) sums deducted from transaction fees by Payment Transfer Module 427 (c) a percentage sum deducted from transactions during the payback period.

The process for fixed sums will be explained first. At any time a recipient can instruct Payment Transfer Module 427 to move a sum of their choice from their account to the account of any pool to which they are in debt using a “my accounts” page of the type that will be familiar to those in the art. Payments received details are stored in Recipient Records Store 565 which updates Pool Records Store 555.

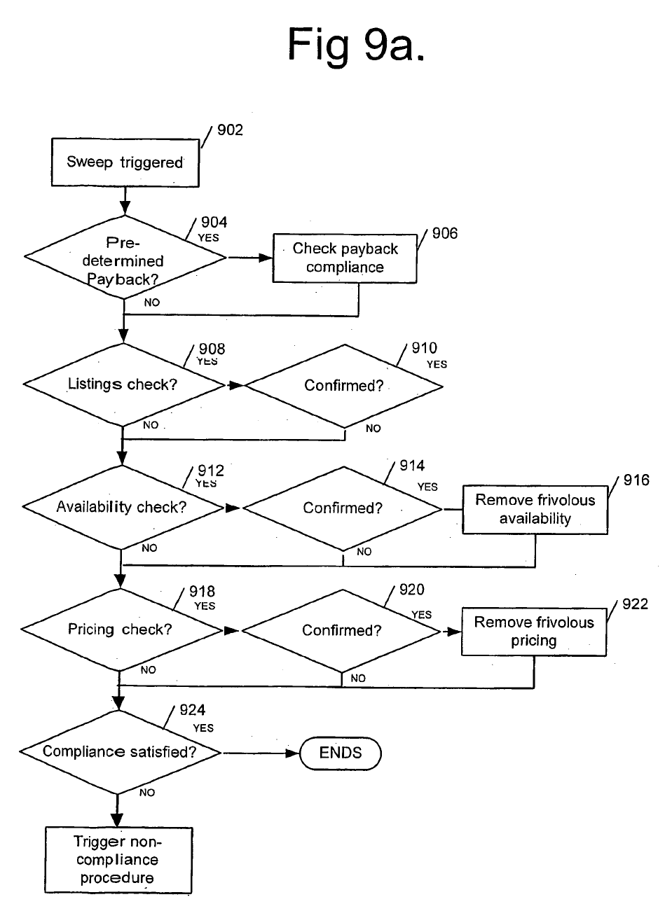

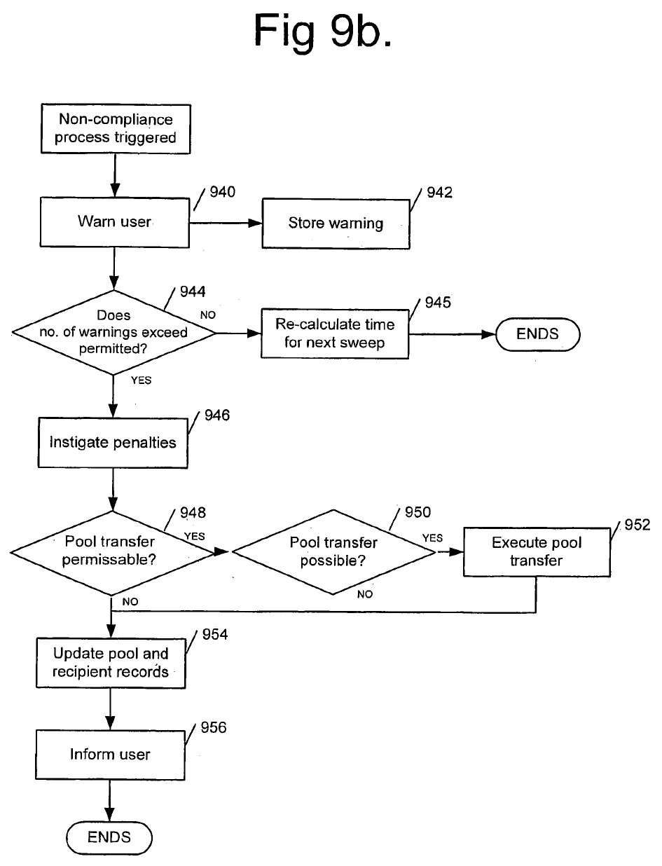

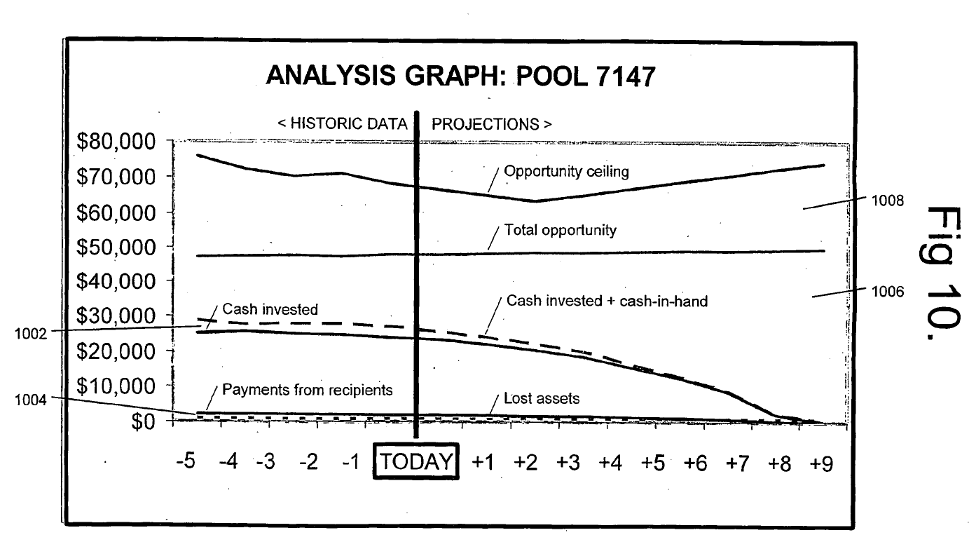

Recipient Records Store 565 contains a list of payments due from recipients and the date/time by which they must be received. When a payment becomes due Recipient Management Module 520 performs the following sequence: (a) calculates the amount the recipient should have paid back to the pool by this date/time by totaling paybacks due for this transfer in Recipient Records Store 565 (b) compares this with the total paid back to this pool in respect of this transfer as stored in Recipient Records Store 565 (c) if the second sum equals or is larger than the first no action is taken, if the amount due is larger than the sum received Recipient Management Module 520 initiates the defaulter management process as described below and illustrated in FIG. 9b. Likewise, payback obligations incurred through acceptance of cash-as-required involvement in transactions are stored in Recipient Records Store 565 and subjected to the same processes. In a preferred embodiment, Recipient Management Module 520 calculates precise $-per-minute rates for the time the cash was withdrawn from the pool and charges accordingly, thereby rewarding early repayment.

When payback is achieved through a levy on a user's earnings in the market a record is created within Recipient Records Store 565 containing the following information: (a) transfer identity (b) types of transactions covered as defined in section 618 of Pool Records Store 555 (c) amount to be deducted as defined in section 618 of Pool Records Store 555 (d) start and end date/time of payback period. When transferring cash between buyer and seller Payment Transfer Module 427 is thus able to check with Recipient Records Store 565 if any is to be deducted for a pool. Cash thus diverted is recorded in Recipient Records Store 565.

In a further embodiment a pool may combine fixed sun charging with a transaction levy. Thus the pool creator would enter conditions in section 618 within Pool Rules Store 550 that stipulated, perhaps, “capital plus 2% paid back within payback period with 5% levy on earnings in defined markets during payback period”.

### Managing Recipient Compliance

Recipient Management Module 520 ensures that each recipient conforms with the payback dates/times, amounts, listings and approved channels documented in the pool rules. It achieves this by sweeps of each recipient's activity. The processes performed will now be detailde with reference to FIGS. 9a and 9b.

A sweep by Recipient Management Module 520 of a particular recipient is initiated, at step 902 each time a date/time trigger stored in Recipient Management Module 520 is reached. Said triggers may be (a) scheduled at the time the cash was accepted by the recipient based on the timetable for obligations and payback set out in the pool rules, for example if availability to sell had to be input a week in advance a sweep might be initiated for every Sunday midnight during the payback period starting a week earlier (b) initiated by Recipient Management Module 520 itself as the result of unsatisfactory compliance in a previous sweep.

At step 904 the process checks whether the rules of this pool, stored in Pool Rules Store 550, mandate payback of a pre-determined amount (the alternative is that the pool makes its return on percentage deduction from market activity or requires no cash payback because it awards grants rather than makes investments). If it does, Pool Rules Store 550 is consulted for the timetable of payback and, at step 906 the recipient's payback record stored in Recipient Records Store 565 is compared to confirm that this recipient has paid back at least the minimum amount specified at this point in the timetable for this pool. The result, “Yes” or “No” with details of any shortfall if “No”, is stored in a temporary record.

At step 908, the entry input at line 618e is checked to see if it specifies any of (a) markets in which the recipient must list their services/goods for sale (b) base postalcode around which they must sell (c) grade at which they must sell. If it does, at step 910, that record is compared with the user's availability data as stored in Seller Database 431. Again, the result, “Yes” or “No” with details of any shortfall if “No”, is stored in a temporary record.

Step 912 checks whether the pool rules contain demands on units of sale to displayed as available during the payback period. Such demands being input through line 618g. If required, at step 914 those demands are compared to the user's availability stored in Seller Availability Record 431b for the period covered by this sweep and determined by the “days in advance” requirement of the creator of this pool as defined at line 618h. Again, the result, “Yes” or “No” with details of any shortfall if “No”, is stored in a temporary record.

In a preferred embodiment, if availability is acceptable the pattern of listing availability within Seller Availability Record 431b is scrutinized to ensure the recipient is not entering frivolous availability. Any availability which resulted in a sale is excluded from this process. This check is necessary so recipients can not take the cash and then fail to comply with the spirit of any resulting obligations by creating patterns of listings which ensure they are likely to be excluded from making any sales.

Frivolous availability might be defined as any units for sale of at least the minimum demanded meet the following requirements when compared to historic market data over a given period pertaining to the market(s) in which the seller is mandated to be available. Said data being stored in Transaction Database 433: (a) sale is offered for times when there is a pattern of demand (b) sale is in quantities of units of sale for which there is a history of demand (e) availability is listed with sufficient advance notice compared to the time between point of purchase and delivery of service or goods for the appropriate market, that is a user can not be listing availability only hours ahead in a slow moving market where typically buyers purchase weeks ahead (d) availability remains in the market for a period in which a sale is likely, that is a user can not attempt to avoid being hired by putting availability into the market and then withdrawing it minutes later (e) the conditions of a sale stored in Seller Parameter Record 431a have not been set so as to make sales unlikely by restricting area of sale, shift length or other settings below averages of sellers who are making sales in the appropriate market (f) Seller Contactability Record 431c shows this seller is displaying at least the average levels of contactability as are being displayed by those who are successfully making sales in the given time period in the stipulated market or markets.

Thus the search for frivolous availability might follow these steps (a) establish average travel distance involved in successful transactions in the market in which the present seller is required to list, that is the distance travelled from seller's base postalcode to place of transaction in a standard timeframe, for example 12 weeks (b) isolate all completed transactions within that market and timefrane where the place of transaction was within the averaged travel distance from the present seller's base postalcode (c) from that pool of transactions plot the following (i) mean seller unit price (ii) percentage of purchased units in each hour of the week (iii) percentage of purchases for each increment of period-of-notice stored in Market Rules Database 434 (iv) percentage of purchases in each increment of other relevant parameters of sale stored in Market Rules Database 434, for example shift length in the case of temporary work markets (d) define a mean for each of the ranges just calculated (e) exclude any units of availability that are above the mean in case of pricing or would be excluded from sales because they are below the mean in the case of restrictions on sales. For example if the mean shift length was 2 hours, any availability that stipulated a minimum shift length of 4 hours or more would be deemed frivolous. This may be fine tuned by allowing a percentage above or below the mean.

If the market in which the recipient is listing their availability has very few transactions, perhaps less than 100 in a 12 week period, a wider pool of data must be used to produce mean figures for comparison, for example the country as a whole. It will be appreciated that the recipient's term's may allow the individual to list in multiple markets and this would involve searching all of them to produce data for comparison. In a simpler embodiment, frivolous availability could be (a) defined rigidly for each market in Market Rules Database 434, that is there is a definition of frivolous availability defined by (i) hours of the week (ii) distance of travel to be made available (c) maximum permitted unit price within that zone of travel (d) acceptable parameters for all relevant parameters of sale for that market. In an alternative embodiment, there might be such rules across the system of markets as a whole designed to disallow availability outside those rules for the purposes of compliance with recipients' obligations.

At step 918 Pool Rules Store 550 is checked to see if this pool requires that recipients display a particular price during the payback period. If so, step 920 compares the base price for this seller stored in Seller Parameter Record 431a with averages for successful sellers in the stipulated area and market(s) to ensure they are within the percentage of average that was input by the creator of the pool at line 618f. Further, at step 922, the seller's entries in Seller Parameter Record 431a are checked against averages for appropriate successful sellers to ensure this seller is not entering frivolous pricing on any parameter and thereby hoping to price themselves out of sales for which they should qualify. Again, the result, “Yes” or “No” with details of any shortfall if “No”, is stored in a temporary record.

At step 924 the temporary record is read to see if this sweep shows the recipient has complied with the requirements to which they acquiesced when they accepted cash from this pool. If so the process ends, possibly with a message to assure the recipient that they are behaving as they should. If not, the non-compliance process is instigated. Again, this could include the sending of a message for example itemizing units of availability that were deemed frivolous and the reason for that designation.

The process initiated when Recipient Management Module 520 finds non-compliance will now be detailed with reference to FIG. 9b.

At step 940 a message is generated detailing the fault and sent to Communications Processor 305 for onward transmission to the relevant user. In a preferred embodiment the text accompanying a warning would be determined by the number of warnings relating to this user in Recipient Records Store 565. That warning is stored at 942 and at 944 the user's number of warnings relevant to this payback period in this pool is totaled and compared against a maximum permissible stored in Definitions Data Store 570. If the recipient is within the permissible number of warnings the time of the next sweep is re-set within Recipient Records Store 565 at step 945. The re-calculation might be based on rules stored in Definitions Data Store 570 relating to the number of warnings issued; the frequency of sweeps narrowing as warnings increase. The following table acts as an example showing the percentage of the scheduled time between sweeps that the next sweep will occur with number of warnings:

| | NEXT SWEEP OCCURS AFTER THIS % OF |
|---|---|
| | TIME BEFORE THE NEXT SCHEDULED |
| WARNINGS | SWEEP |
| 1 | 75% |
| 2 | 50% |
| 3 | 25% |
| 4 | 10% |

Thus, a defaulting user is checked with increasing frequency and given multiple warnings before finally having the penalties in their contract activated.

If the maximum number of warnings has been issued step 946 looks up the record for any penalties to be applied in Pool Rules Store 550. This selection was input by the pool creator at section 620. It then applies penalties as follows (a) if loss of grade is stipulated, User Maintenance Module 428 is instructed to downgrade the user (b) if loss of endorsers' grade points is demanded, User Maintenance Module 428 will deduct the required number of grades from users listed in Seller Database 431 as endorsers of this seller, it will seek to do so in proportion to each endorser's grades, that is; it starts by removing one grade point from each endorser then a further grade from each of the endorsers above grade 4, then each above grade 3, then each above grade 2, then each above grade 1, then each above entry level and repeats the process until the required number of points have been deducted (c) if there is a contractually enforced penalty, that is a freetext entry, this can not be applied by the system and details of the recipient are forwarded to the investors in the appropriate cycle who can begin recovery through other means.

At step 948 Pool Rules Store 550 is looked up to see if the recipient's obligations can effectively be passed to another pool. This option is selected at line 620b. If this option is selected step 950 initiates Recipient Engagement Module 515 to find a new pool for this debt on the basis of the following details: (a) function of the pool as in the case of the current pool (b) specified market(s) and geography include this user (c) spending control as in the present pool or less tightly defined (d) payback time must exceed that of the current pool and be such that this user's pattern of payback would be within the terms of the second pool had the user originally contracted with that pool (e) grade of user and endorsement points are as they stand after step 946 has completed.

If this search produces a second pool that will take on this user that (a) has no freetext contractual obligations attached (b) is within a maximum percentage increase in payback time/costs stored in Definitions Data Store 570 then step 952 moves the obligations from one pool to another. Payment Transfer Module 427 takes the required sum, outstanding capital plus $-per-minute charges, from the new pool and transfers it to the balance of the old which records this debt as having been paid. If there is no ability to transfer the debt to any other source then the pool writes the debt off as lost assets for this cycle.

At step 954 all records within Recipient Records Store 565 are updated for the pool(s) concerned and within Recipient Records Store 565 for the recipient involved. At 956 a message is prepared that explains all the actions taken and sent to Communications Processor 305 for onward despatch to the user concerned and any of their endorsers who have been penalised.

In a further embodiment pool creators might be given the option of stipulating that a pool will not accept users rejected from other pools. However, the ease with which new pools can be set up should make this unnecessary. Investors may see opportunity in creating pools aimed specifically at catching those users who default on commitments to the high demand (but likely to be low charge) pools. If those newly established pools charge too high a rate other pools will be set up to undercut them. Thus it is possible a defaulting user could be moved through multiple pools, each pricing their cash at a precise, but increasing, market rate to reflect his increasing undesirability as a borrower.

### Payouts to Investors

As has already been shown, Investor Records Store 560 stores a list of payouts due back to investors. As each date/time is reached Pool Management Module 510 is triggered to perform the following sequence: (a) read this investor's current percentage of the appropriate pool/cycle in Investor Records Store 560 (b) read current value of the appropriate pool cycle in Pool Records Store 555, that is its cash in hand and its current cash out with recipients minus its lost assets (c) instruct Payment Transfer Module 427 to transfer the investor's percentage of that value to the investor's account (d) record amount paid in Investor Records Store 560 (e) recalculate the current value of the cycle. Funds may be paid out at the end of the investment period or periodically, in proportion to the outstanding liabilities and each investors percentage of the cycle as money is repaid.

### Reporting a Pool's Performance

It will now be explained how a pool reports its activities and results. Every transaction by a pool is stored in Pool Server 500. This data is used to produce a range of metrics for investors and potential investors in that pool. These metrics are used extensively by upper pools that apportion cash, often for short periods to the most attractive lower pools, the metrics used must therefore be consistent across all pools regardless of their function.

Pool Records Store 555 contains information, both current and historical, for each pool that includes: (a) payments received from each investor and date/time said payment is due to be returned with its earnings (b) payout tranches made to each recipient with latest date/time by which they are due to be returned (c) lost assets, that is funds which have passed the date/time by which the recipient should have returned the capital and the charge for its use (d) dollar-per-minute charges received from recipients.

Using this data Pool Records Store 555 is able to constantly calibrate: (a) total cash currently held by recipients (b) current cash-in-hand balance (c) cash return to investors, calculated by subtracting lost assets from dollar-per-minute income within any specified timeframe (d) cash utilization, that is the amount of cash currently in hand compared to that in the hands of recipients (e) cash turnover, that is what percentage of any given time frame a dollar currently has to wait in cash-in-hand before being allocated to a recipient. Obviously these figures can be displayed as percentages of each other. Additionally, Pool Records Store 555 contains records of when cash is due back from recipients and when it is due back to investors. Thus it can produce projections of cash movements for the future up to one investment period length for this pool.

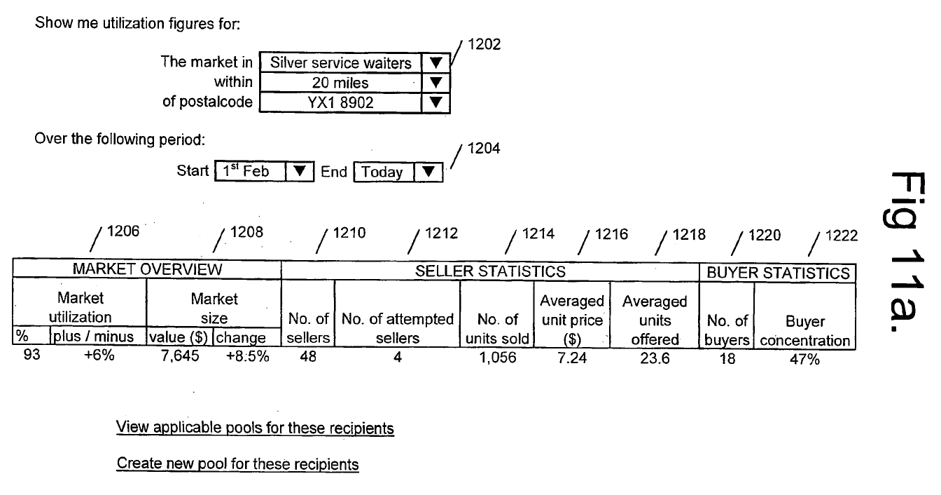

FIG. 10. shows a standard reporting graph produced by Statistical Information Module 525 using historic data from Pool Records Store 555 for one pool that has a nine day investment-period length and for which a user has requested four days of historic data and a full investment period of projections. It is centred on a line that represents the present moment, everything to the left of the line is historic data, everything to the right is either (a) based on known liabilities or (b) a projection by Statistical Information Module 525. The graph is displaying in units of a day but could, for comparison purposes, display in hours or weeks.

In the present graph all figures are based on averaged across-the-day balances for all cycles. Cash invested and cash-in-hand projections are based on a scenario where there is no further investment into the pool: it simply collects what is due from recipients during the investment period and pays capital and income back to investors. If this scenario prevailed it would therefore be empty at the end of the investment period. Payments from recipients are projected based on what is due back according to commitments accompanying the invested cash. (In the case of investment pools where the pool is taking a percentage of earnings this line will be a projection based on historic percentage return.) Lost assets are likewise projected based on historic percentages.

There is further data that can be mapped onto a pool's reporting and this will now be disclosed. Recipient Engagement Module 515 is able to periodically recalculate the number of traders or transactions qualifying for a particular pool, this can be multiplied by the maximum allocation to produce a real time figure called the “opportunity ceiling”. That is, the sum required if every trader or transaction eligible for funds from this pool took out the maximum allocation. Projection is based on data generated by Opportunity Analysis Module 535 as it maps opportunity in pools using methodology that will be disclosed later in this document.

A further metric is produced by Statistical Information Module 525 which ensures every enquiry for funds from Recipient Engagement Module 515 is stored in Recipient Records Store 565 meeting these three conditions (a) the enquiry resulted in a transaction (b) this pool was qualified to provide the funds required (c) another pool provided the funds, probably because it was cheaper for that transaction. The value of all transactions defined by (a) and (b) within a given timeframe is called the “total opportunity” for a pool, that is the cash it could have allocated if there had been no cheaper competing pools. That part of the total accounted for by (c) is known as the “surrendered opportunity”, the investment lost to other pools that are either better value, or more attractive in terms of their clauses.

These above figures incorporated in the graph illustrated in FIG. 10. create further tools for analysis that can be explained with reference to the graph. A large space 1002 between cash invested and cash-in-hand signifies a pool with few applicants and cash sitting idle. A small space 1004 between the lost assets line and that for payments from recipients demonstrates large losses from defaulters among recipients. Space 1006 shows historic and projected “surrendered opportunity” a larger than average gap suggests an overpriced pool or one that contains conditions making it unattractive to target recipients. Space 1008 represents the “opportunity wastage”, the gap between cash being used for the overall opportunity at which the pool is targeted versus the amount of cash theoretically available for that opportunity, a large gap suggests maximum allocation figures, which limit a pool's ability to service new recipients, are too big for maximum efficiency.

Potential investors are able to call up a page similar to that in FIG. 10. that allows them to specify multiple pools. Analysis graphs for their chosen pools can then be mapped onto each other utilising display methods known to those in the art for intuitive comparison. Statistical Information Module 525 is also able to produce tables of comparisons between any selected pools. This functionality is useful only to long term investors, those seeking maximum short term returns would be better advised to use an upper pool as will be described later in this document.

### Making Investment Decisions Among Multiple Lower Pools

Once multiple pools have been created, each promoting certain types of market activity, an investor can achieve far greater precision in the way she allocates her cash. Apart from creating a completely new pool as previously described she is able to (a) view performance comparisons of the various pools (b) create a “breakaway pool”, that is a pool that replicates most of the parameters of an already established pool but “cherry picks” the key opportunity within its remit then undercuts the original pool with a lower rate for the more tightly defined opportunity (c) study data about the ongoing need for investment or underwriting in underlying markets (d) invest in pools which have been created automatically by Pool Server 500 because an opportunity has been identified to which no investor has so far responded.

Pool performance comparisons are generated within a screen accessible by any user who defines their chosen parameters in a screen generated by Statistical Information Module 525. Said parameters can include definitions of the desired pools' (a) function (B) market or markets covered (c) grades of users covered (d) postal code included in the pool's remit (e) investment period length.

The resulting screen contains a list of pools with the following information about each tabulated: (a) current rate of return to investors (b) averaged rate of return over selected period . Additionally the user can click through to: (a) the pool's analysis graph as exemplified in FIG. 10 (b) the pool's rules as stored in Pool Rules Store 550. An investor may wish to instruct Statistical Information Module 525 to include pools that currently have no cash in a search. These pools will still have their “total opportunity” displayed, that is the potential demand for their offering, and a user may wish to reactivate said pools with a cash injection.

While viewing details of any pool a user is able to select “create breakaway pool”. This creates a screen as shown in FIG. 6a. and 6b. populated with all the details of the present pool. One or more definitions can then be changed to create a new pool. This allows complete efficiency in matching investors' money with evolving opportunity. For example an investor noting the success of a pool that lends money to users of grade 4 or above at 5% return per annum, with a variety of requirements that lenders must meet and obligations that accompany the loan, may set up a breakaway pool that replicates all the requirements and obligations but restricts the opportunity to only grade 6 users, who have most to lose from defaulting, while ensuring it is more competitive to said users than the original pool by charging only 4.5%.

In a further embodiment, the creator of a pool may be able to define pricing relative to another pool inputting, for example that “this pool always charges a dollar-per-minute rate of 0.2% less than pool 3174 until the specified pricing minimum is reached”. This facility is particularly useful for breakaway pools but needs to be limited to avoid circular pricing in a way that will be familiar to those in the art.

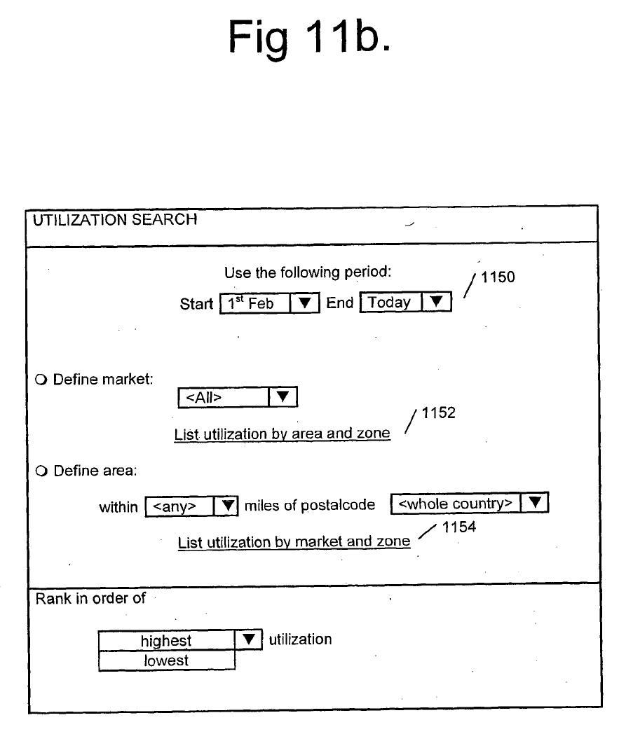

To make precise investment decisions, investors need an array of information about activities in the marketplace underlying the present invention. In the case of the exemplary “GEMs” marketplace described at the beginning of this document, this can be created from data stored in Transaction Database 433. Any potential investor who believes they have spotted a market inefficiency can immediately check whether it represents a suitable investment opportunity. This will be explained with reference to FIG. 11a.

In this example a user, seeking to hire silver service waiters for an event in York discovered those individuals were charging prices far above what he would expect. He is able to instruct Opportunity Analysis Module 535 to show an overview of that specific market within the system over his chosen timeframe.

The screen returned by this instruction is represented in FIG. 11a. and will now be explained. Section 1102 allows the user to define an underlying market and a geographic range within which any sale must have occurred. In a preferred embodiment a user is able to enter multiple markets and/or multiple geographies as well as a range of seller grades. At 1104 they are required to define a period of time. Thus, a finite number of historic transactions can be assembled from data within Transaction Database 433. These transactions include (a) sellers who have listed availability to sell and the periods for which they have done so (b) purchases made, by whom and for when. In each case the number of units for sale or involved in a sale, in this case hours of a worker's time, are stored. Aggregated information output about that selection of transactions is as follows.

1106 displays the “market utilization”, that is the number of hours bought as a percentage of the number of hours offered for sale. It displays the percentage rise or fall in this number from start to end of the defined period. 1108 totals the value of all defined purchases and the averaged percentage rise or fall in daily turnover in the defined period. 1110 shows the number of individual traders who sold their services in the defined market, area and timespan. 1112 reveals the number of sellers who listed their services and failed to make any sale.

1114 displays the total number of hours sold within the defined pool of transactions. 1116 divides that number by the total market value. 1118 represents the average number of units offered by each seller per week. 1120 is the number of entities who made a purchase within the defined transactions and 1122 is a measure of buyer concentration, probably showing the percentage of purchases made by the largest buyer or alternatively the ratio of percentage of purchases by value by the biggest buyer to the percentage of purchases by the second largest buyer. A market highly concentrated around a small number of buyers might be deemed unattractive because it may be less stable that one with more evenly matched buyers. It will be appreciated that the data given could be represented graphically using methodology well known to those in the art.

Thus it is clear to the viewer of this screen that the market for silver service waiters around York is one of very high utilization and high prices that is not at the mercy of one dominant buyer. The investor who sees an opportunity in resolving this obvious shortage may consider a range of options, all of them backed by information from Opportunity Analysis Module 535. Options include (a) upskilling: seeking a pool of workers in a local low utilization, low earnings, market who can be offered training in silver service waiting with a return from their income thereafter (b) migration: finding silver service waiting staff in other parts of the country with low utilization and low earnings then funding their travel to, and accommodation in, York for a fixed term with a return on their resulting earnings (c) seeking information about availability of equipment from a secondary marketplace that will be essential for many sellers in the primary marketplace for example researching the lawnmower hire sector as a means of understanding low utilization in the “home gardeners” market. It may be that investing in reliable gardeners who need to buy a lawnmower to be more effective is an investment opportunity. All of of these require utilization mapping of activity in the marketplace underlying the present invention. This process will now be explained with reference to an exemplary screen as shown in FIG. 11b.

Section 1152 allows the investor to define a market for which they seek utilization analysis. Opportunity Analysis Module 535 then produces a color coded map where each seller in the defined transaction is (a) represented as a pixel on a map according to their base postal code (b) is color coded according to the personal ratio of units offered to units sold in the defined period. Thus the viewer is presented with a representation of the area of operation with utilization of silver service waiters perhaps showing as very pale blue in areas of utilization below 10% and very dark blue in areas where it is above 90%. In a further embodiment the specified transactions for utilization analysis could include only those within specified seller grades. This will reveal areas where already qualified sellers may welcome the opportunity to work in the York area for a period.

Likewise, at section 1154, the viewer can specify an area, within 20 miles of York perhaps, and have markets displayed by averaged utilization ranking within the defined period. This will reveal which markets in York are likely to contain traders who would like to retrain as silver service waiters.

Thus the investor may choose to create a pool with tightly defined potential recipients based on their research above. Utilization mapping functionality is particularly applicable to awarding of grants or welfare payments through the underlying marketplace. Using Pool Server 500 and Pool Creation Module 505 a grant awarding authority is able instantly to (a) establish areas where individuals are genuinely attempting to sell their services at a realistic price but having no success (b) identify opportunities for which said individuals could be trained (c) create any number of pools specifically targeted at individuals who have worked their way up to a given grade perhaps in a “market” for voluntary work that entails payment in electronic vouchers but have remained based in an area of low utilization across all markets (d) trickle funds progressively into upskilling those individuals by setting up additional pools that progressively widen the geography, applicable grades or qualifying market activity for recipients.

In a further embodiment of the present invention Pool Rules Store 550 may allow a pool creator to stipulate partial payback on their investment. Thus, within section 618 of the screen shown by FIG. 6b the user would be able to specify that only a given percentage of the sum invested was to be paid back according to the means outlined in the rest of the section. This is particularly useful for grant givers.

In a further embodiment of opportunity analysis within Pool Server 500, the investor may be able to call up details of any decisions by earlier investors likely to resolve the opportunity they are investigating. Thus Pool Rules Store 550 would be searched to create a list of all pools that were specifically funding training for silver service waiters within York and total the number of recipients and beginning of payback period. It is therefore able to produce information about a likely pipeline of new sellers that can be factored into graphical displays of current utilization. In a further embodiment, utilization mapping might offer a “averaged utilization over time” option, that is: figures for utilization are averaged over blocks of perhaps 3 months so that genuine trends can be isolated rather than short lived peaks.

In an alternative embodiment, the screen shown in FIG. 11a. could average data about underwriting within a specified pool of historic transactions. Such information might include (a) percentage of transactions that were underwritten (b) averaged amount of cover provided (c) averaged period for which cover was held in a separate account (d) averaged lost assets, that is funds that were paid out as compensation (e) average $-per-minute charge.

### Automated Creation of Lower Pools

In a further embodiment, Opportunity Analysis Module 535 may trigger Pool Creation Module 505 to create a new pool automatically when it can identify conditions including (a) an opportunity for investors in market trends (b) a gap in the range of existing pools (c) a pool that has very low or very high “opportunity wastage” as identified in section 1008 of FIG. 10.

The table below gives an outline of some of the conditions required to trigger the creation of a new pool and the parameters of the resulting pool for each of these factors. All figures are exemplary only, actual figures for triggering creation of a new pool would be stored in Definitions Data Store 570.

| | CONDITIONS THAT TRIGGER | KEY PARAMETERS OF NEW |
|---|---|---|
| | CREATION OF NEW POOL | POOL |
| OPPORTUNITY | Identifying any individual seller in a | Identify related market(s) of lowest |
| FOR INVESTORS | market of average transaction length <8 | utilization in the area around identified |
| | hours who has >95% utilization over >4 | seller - create pool that funds high |
| | weeks. Within average travel distance for | grade sellers in that market to transfer |
| | said market said seller must be surrounded | to high utilization market. |
| | by sellers with utilization of >90% | |
| | averaged. | |
| GAP IN RANGE | The system constantly examines grids of | Majority of parameters as in the pools |
| OF EXISTING | available pools listed by function, | surrounding the empty square in the |
| POOLS | required, grade of recipient, applicable | grid but key data populated so the |
| | markets, maximum cash allocation and | empty square is filled by this pool. |
| | spend/payback period. One such grid may | |
| | be for “loans available to Grade 5 or above | |
| | sellers”. Columns in the grid show the | |
| | maximum cash allocation of all such | |
| | pools, rows show the maximum payback | |
| | period. Where a square in the grid is blank | |
| | a new pool is created. The granularity of | |
| | the grid increases with overall number of | |
| | pools in the system. | |
| ABNORMAL | “Opportunity wastage” is the gap between | As in the original pool but with |
| “OPPORTUNITY | all funds theoretically available for a | changed cash allocation figure. |
| WASTAGE” | particular opportunity and the funds being | |
| | used. Wastage <5% suggests recipients all | |
| | seeking close to maximum cash and a need | |
| | for a new pool that increases maximum | |
| | cash allocation by 25%. Wastage >50% | |
| | suggests cash sitting idle and a need for a | |
| | new pool with maximum cash allocation | |
| | reduced by 25% that will be more | |
| | attractive to investors. | |

Automatically created pools would be limited in their definitions, serving a broad opportunity rather than very specific opportunities for which the insights of individual investors are required. Referring to FIG. 6a. and 6b., automatically created pools would (a) use averaged data for sections 606 and 608, said averages being deduced from data stored in those sections across all of Pool Rules Store 550 (b) be populated with averaged listings requirements in section 618e,f,g,h; said averages deduced from the relevant market as a whole by Opportunity Analysis Module 535 (c) have standard inputs, as stored in Definitions Data Store 570, for section 620 (d) have no freetext entries. These automatically created pools could then receive cash from investors or through the upper pool mechanism that will now be described.

### Creating an Upper Pool

An upper pool is a pool of cash that moves its money between lower pools but does not deal directly with recipients. Their purpose is to enable “hot money” that moves, as required and according to investors' parameters, between the most promising lower pools. Thus, an upper pool might be established to invest in “any lower pool paying more than 5% return averaged over the last 4 weeks that has less than 10% of its value as cash-in-hand with an investment period of less than 10 weeks”. This upper pool will then put cash into lower pools across multiple functions and multiple markets with widely varying obligations placed on recipients as long as each pool meets those criteria. Proceeds are then taken from the lower pools, combined in the upper pool within cycles defined by time and paid to investors in the way already detailed for lower pools.

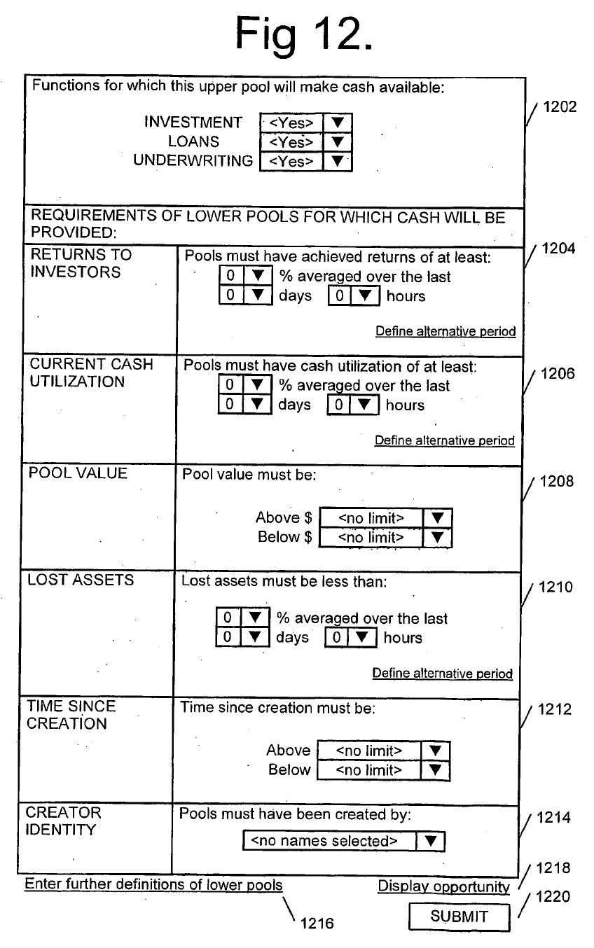

An upper pool is created by selecting “create an upper pool” on the page offered to any user by Pool Creation Module 505. This delivers a screen as illustrated in FIG. 12. which will now be described.

Upper pools can be limited by function or can invest in pools performing any number of functions. This is determined by the creator's entry at section 1202. The screen then allows a list of parameters based on pool performance to be input.

Line 1204 allows the selection of lower pools to be defined by the dollar-per-minute charge they have 30 achieved over a historic period either (a) ending with the current moment or (b) a historic period defined in a calendar of the type suitable for defining a date range that is well know to those in the art. An investor may, for example, wish to invest in pools that were doing well at this time last year. The investor may select “highest” in this selection box signifying that lower pools are to be selected on the basis of all the other parameters listed within FIG. 12. and then cash invested from the upper pool until either (a) the upper pool's cash allocation limit is reached (b) the lower pool contravenes one of the upper pool's parameters, for example the cash received from the upper pool has pushed its cash utilization ratio to the cut out level stipulated by the upper pool. At this point the upper pool will move down to the next highest lower pool meeting all its parameters and repeat (a) and (b).

Line 1206 allows cash utilization to be defined, that is the percentage of pool value represented by cash with recipients. A high utilization demonstrates demand from recipients and little cash-in-hand. The investor may select “highest” in this selection box signifying that lower pools are to be selected on the basis of all the other parameters listed within FIG. 12. and ranked by this factor with cash invested from the upper pool in the way explained above.

At 1208 the investor can set limits on the value of the lower pools in which he will invest. He may for example wish to put funds only into large and stable pools or may be excited by small, volatile and likely to be highly targeted pools. The investor may select either “highest” or “lowest” in this selection box signifying that lower pools are to be selected on the basis of all the other parameters listed within FIG. 12. and ranked by this factor with cash invested from the upper pool in the way explained above.

An investor may wish to avoid pools with historically large percentages of lost assets caused by defaulting recipients. His tolerance for this performance metric can be set at line 1210. The investor may select “lowest” in this selection box signifying that lower pools are to be selected on the basis of all the other parameters listed within FIG. 12. and ranked by this factor with cash invested from the upper pool in the way explained above.

Line 1212 enables the investor to limit pools in which his new pool will invest by the time they have been in existence. Thus, he may wish to put money only into pools that have solid historical data or he may wish to bet on early stage pools that are pioneering new opportunities for investment. Again, the investor may select either “highest” or “lowest” in these selection boxes signifying that lower pools are to be selected on the basis of all the other parameters listed in FIG. 12. and then cash invested from the upper pool in the way explained above.

At line 1214 the creator may specify that he wishes only to invest in lower pools established by certain individuals whose investment insights he values.

Clicking on line 1216 brings up the screens illustrated in FIGS. 6a. and 6b. and allows very detailed controls to be input with pools eligible to receive cash defined by their exact entry within Pool Rules Store 550. The following sections of these screens are omitted because they are not relevant in the context of defining an upper pool (a) 602 which has already been covered by the potentially multiple entries described above (b) 616 because freetext entries can not be meaningfully understood by an upper pool (c) 620d for the same reason. Additionally in this context, section 606 defines the maximum amount the upper pool will have invested at any one time in any one lower pool.

At line 1218 Recipient Engagement Module 515 is triggered to display the ranking of lower pools this upper pool would produce based on the criteria input. Said information is taken from Pool Records Store 555 in conjunction with Pool Rules Store 550. Clicking on Submit button 1220 triggers the following (a) a check that this new pool is unique among existing upper pools (b) the creation of a new record in Pool Rules Store 550 that includes an extension identifying the record as pertaining to an upper pool (c) the creation of a blank record in Pool Records Store 555 to await details of transfers in and out of the new pool (d) the opening of a digital account for the new pool which Payment Transfer Module 427 can transfer cash into and out of. It will be clear that the processes of taking in funds from investors, making payments into the accounts of lower pools through Payment Transfer Module 427, making payments back to investors according to their mandate and reporting pool activity can be broadly the same as outlined for lower pools.

Upper pools do not wait for a recipient or transaction to request cash. Instead, Recipient Engagement Module 515 is activated to search lower pool records in Pool Records Store 555 and Pool Rules Store 550 in search of a pool into which to put cash at any time that the pool has funds to be placed. If more than one eligible pool is returned and the upper pool does not contain a “highest” factor by which to rank said pools it allocates cash evenly between them until the upper pool's minimum cash allocation figure as input at section 1206 is reached in any individual pool at which point it continues to disburse to the remaining pools and so on until (a) the upper pool runs out of cash or (b) there are no eligible lower pools left. This cycle is continuous as cash can be taken out of a lower pool at any time.

If no lower pool meeting an upper pool's criteria can be found individual allocations of cash can do either of the following according to the investor's instructions (a) sit in the pool's account trickling through cycles waiting for an opportunity to be placed (b) be dispersed to investors after the time period of their choosing (c) be transferred to other pools according to individual instructions.

If one or more upper pools is trying to simultaneously put cash into a lower pool the following methodology is applied by Pool Management Module 510: (a) the upper pool with the lowest acceptable S-per-minute rate is accepted first (b) if more than one pool has an identical rate that is the lowest the upper pool with the most cash in hand is accessed, this encourages investors to leave money in the system.

In a further embodiment the parameters for selection of lower pools might be weighted according the creator's individual preferences. For example an upper pool might be instructed to score 10 points for each percentage point of return, 25 points for each percentage point of utilization and so on. The points are totaled, enabling a ranking of lower pools and that determines the upper pool's investment decisions.

In a mature system it is likely the bulk of investment would be received through upper pools because it removes the need for investors to get involved in details of obligations and conditions or tracking performance of individual lower pools that could at any time be attacked by a more competitive “breakaway” pool targeting a key part of the overall opportunity. In a matured system it is likely investors would be offered a screen that allows them to set rules for the disbursement of their cash based on (a) minimum $-per-minute rate at which it is to be allocated (b) period of time before cash is returned (c) acceptable risk factor, that is the historic percentage of cash invested as lost assets within a lower pool. If the required upper pool was not available it would automatically be created.

It should now be clear that the present invention is able to (a) allow any user to create a first raft of investment pools (b) supplement those first pools with automatically created additional pools with increasing precision as usage deepens (c) enable any user to set up a pool that creates a new investment opportunity (d) report the performance of all pools using unified metrics (e) allow automated allocation of cash to lower pools as it is required at the most competitive rate. Thus an investment system is established that is able to (a) respond promptly to need in the underlying market (b) iron out inefficiencies in the underlying marketplace (c) allow investors to chose between high risk untried investment strategies and low risk strategies predicated on a wealth of historical data (d) remove overheads involved in investment that are an inevitable part of investing through institutions and traditional exchanges, particularly when small sums of investment are involved. The result is a system in which cash flows freely in small, very precise, amounts governed by investors' appetites for risk/reward and the needs of recipients and their track record of reliability.

### Further Refinements

There are a number of refinements to the system as described above that will now be disclosed. Their technical requirements will be apparent to those skilled in the art. (a) flagging some pools as “ultra safe”, that is, it is clear that any defaulted debt can always be transferred to a second, less favourable for the recipient, pool so lost assets are always going to be nil unless the less demanding pools cease to be attractive to investors (b) automatic allocation of spare cash within a pool, that is cash that has either not yet been taken by a recipient or has been repaid early, to other pools until it is required, receiving pools are likely to be those deemed “ultra-safe” to avoid loses of a type not authorised by investors (c) similar placement of cash put in holding accounts by underwriting pools (d) allowing underwriting pools to issue more cover than they have funds available, working for example on the assumption that, historically, if only 2% of cover will become lost assets therefore the pool can safely issue $95 of cover for every $1 it holds (e) pools could make combined investments to maximise cash utilization, for example assume a user wishes to take out a loan of $500 but the best value pool for which she qualifies has a maximum allocation of $300 or a higher allocation but only that sum as cash-in-hand; she might be able to take that while also taking $200 from the next best value pool thus creating two, or more, entries in her “my liabilities” record within Recipient Records Store 565 (f) investors can opt for roll-over investments where their profits and capital are automatically re-invested in the same pool until they give note of withdrawal, the notice period perhaps being the investment period of that pool (g) users of Pool Server 500 might be allocated a grade separate from any grade in the underlying market based purely on their record of payback and meeting obligations in respect of commitments made with that server.

### Alternative Means of Achieving the Objects of this Invention

It will be clear there are alternative ways of achieving the aims of the present invention: to facilitate a broad range of investment through direct interactions with traders and individual transactions in an electronic marketplace. One alternative is to match individual users or individual transactions with individual investors so that each investor in effect has a personal pool of cash which they can release either according to pre-set rules or after deciding on an application from users or the system itself. Another is to combine all funds invested in one large, multi purpose, pool that makes different kinds of investment available and combines the returns. A further option is to have only one pool of cash that performs one function across the whole market. These alternatives may be useful in the early days of a system of online markets. However, none of them offer the combination of control for all parties, potential for innovation and precision of reporting as the architecture outlined in this document which allows for multiple pools with cash moving freely between them.

### Further Embodiments

A Rudimentary Banking Service

The system so far described is predicated on digital-fund transfer between investors, pools and recipients. It will be appreciated that many individuals would like to lend, invest or receive small amounts of cash from the system but can not do so because they hold the cash they wish to use as notes and coins. Likewise, recipients may receive digital money but want to spend it as physical cash. The present invention can contain additional functionality that allows any user to act as a banker, setting up a temporary facility alongside a terminal connected to the system. They are able to take physical cash from anyone with an account on the system and turn it into a digital deposit which can then reap the benefits of all the services offered by Pool Server 500. Likewise, any user with digital cash, perhaps deposited in their account by Pool Server 500, is able to withdraw it as notes and coins. Each banker is able to set his own price for providing this service in a market which is competitive: any other user can provide the same service in the same area for a lower rate. The community banking market operates as an additional sector in the underlying marketplace and can show any user the current location of bankers on the system and the rate charged by each. The process for operating this banking service will now be described.

A user who wishes to act as a banker establishes himself and a terminal connected to the system in an accessible location, this could for example be the porch of his house. He logs on to the system and accesses the market for “community bankers”. Once in that market he inputs: (a) his postalcode location and colloquial directions for anyone wishing to find him (b) the float of physical cash he has available, Payment Transfer Module 427 will use this to create his book-keeping records (c) the sum he will charge for each transaction (d) a codeword to be shown to him that confirms a transaction has completed. He is now in business.

Suppose another user wishes to withdraw $50 from a digital account, the following steps are required once said user is standing with the community banker (a) that user logs on to the banker's terminal, within the banker's page in the community banking market, with their ID and password (b) they are asked how much of the funds in their digital account they wish to take out as cash (c) Payment Transfer Module 427 transfers that sum, plus the transaction charge specified earlier, to the banker's account (d) Post Sale Management module 426 shows the banker details of the transfer along with all or part of his codeword to confirm that the money has genuinely been put into his account (e) the banker gives the user $50 in notes.

For deposits of paper cash the process is reversed. The banker takes the cash, then is able to instruct Payment Transfer Module 427 to transfer that sum, minus his charge, from the banker's account to the user's. The user must type in her details so the system is able to identify the individual. The user is then shown confirmation of the transfer together with all or part of their system password to confirm that the transaction has genuinely occurred.

There are a number of refinements to this market which will now be disclosed. (a) the community banking market could generate a map showing the current location of bankers and their charges at any given time (b) said market may also generate an eye catching default full screen display for bankers announcing their rate to passers-by saying perhaps “Community Banking, 25 cents a transaction” (c) the transaction charge could vary between deposits and withdrawals based on the cash balance of the banker, thus a banker may wish to maintain a physical cash float of $100; as he drops below that, the rate for withdrawals rises and that for deposits falls. The situation is reversed if his physical deposits start to outweigh his digital funds (d) the market may only allow individuals who have attained a certain grade in the underlying marketplace to act as bankers, thus they could lose their grade if it was shown they were unreliable, for example by failing to tell the system when they had ceased operations after a period of trading so they were still showing as open in system displays.

A Market in Existing Positions in Pools

Pools could be established to allow rolling investment possibly used to make substantial sums of cash available to recipients. For example a pool could lends up to $50,000 over 10 years to qualified recipients. Individual investors may not wish to have their cash tied up for that period so ownership of tranches input by earlier investors could be offered for purchase by later investors at a price set by the earlier investor. Said market would probably operate as a listing of tranches for sale sorted by (a) identity of pool (b) time to maturity (c) price sought. Such listing technology is well known to those in the art.

Underwriting Future Prices in the Underlying Marketplace

A modified version of an underwriting,pool as described could be used to allow investors to underwrite the price of future purchases within the underlying marketplace. For example, a pool to underwrite the cost of holiday's next summer could sell the right to buy 7 nights with a grade 6 seller in a given locality within a given timeframe at a maximum price. The period of notice for the purchase would need to be stipulated to avoid last minute premiums distorting the price. Alternately a farmer could seek underwriting against the possibility that his pigs will fetch less than $5 a kilo next June. The process by which cash can be fed from a pool into a transaction to keep the price below a certain level has already been outlined. Creating a pool selling underwriting against price movements requires an additional section for the screen represented by FIGS. 6a. and 6b that allows a pool creator to specify the following parameters: (a) a market and geography defined as in sections 608a, 608b, 608c of FIG. 6a. (b) a timeframe defined by a selected start date and a selected end date (c) required parameters used by Assembly of Options Module 424 to construct individual transactions such as period-of-notice to booking (d) the maximum number of units an underwritten user may purchase or sell under this arrangement (e) a maximum and minimum figure between which is the “acceptable unit price” that this pool will maintain for its recipients.

For each user who purchases underwriting from the pool the maximum cash allocation is transferred to a holding account. This cash is then used by Transaction Handling Module 530 to subsidise the cheapest option meeting the requirements outlined on the screen illustrated by FIG. 2. if it is above the “acceptable unit price” in the case of a user underwriting against price rises. For a seller underwriting against low prices, payout is based on (a) averaged unit prices in the defined market across the timeframe of cover (b) the number of units she sold within that defined market, any sum required to take the average price into the “acceptable unit price” being paid to the user's account In both cases, the end of the defined period automatically becomes the end of the payback period for that pool.

Additional Financial Functions

It will be appreciated that functions apart from underwriting, lending and investment could be offered by the infrastructure within Pool Server 500. They include gambling, users could create a pool, charging a rate of their choosing, for users fitting certain criteria, to offer underwriting against the possibility a given team will lose a sports event next Saturday. Results of the event would have to be input impartially through Definitions Data Store 570.

Welfare Payments

Pool Server 500 could be used as a means of administering welfare payments to users of the underlying marketplace who were genuinely seen to be wishing to sell their services but could not do so because of a lack of buyers. Weekly payments could be subject to a user meeting certain listing requirements which would be checked in the way already outlined by Recipient Management Module 520. If they failed to comply with the contractual requirements as a result of a purchase they could then be downgraded which is itself a potential breach of listings requirements if the pool creator has specified a minimum grade level. Pools for this purpose would make payouts after sweeping listing requirements and a users records of sales in Transaction Database 433. Any shortfall up to a given amount within a given timeframe, probably a week, can then be paid directly to the user's account from pool funds. In a further embodiment the pool may be set to pay up to a given amount each week plus a percentage of the appropriate user's income through sales to further incentivize recipients.

Descriptions of the system above have assumed a wide ranging system of markets. The invention applies equally to a narrow range of markets, for example a market for secretarial services with sectors covering medical, legal, educational and commercial secretaries as a system of markets.

In above described embodiments of the system the Internet, and more specifically web technology, is used for communication between a central computer system and the buyers and sellers. However, it is not necessary to implement the invention using the Internet and the system may, for example, be implemented on local or wide area networks, wireless mobile communications networks, cable tv networks and the like. Similarly, the terminals used by the buyers and sellers for communicating with the central computer system may comprise mobile phone handsets, personal digital assistants, inter-active televisions and the like. Likewise, as it is well known to those skilled in the art, the processing for performing the functions described above may be shared between machines in ways other than that shown in the illustrated embodiments.

No doubt many other effective alternatives will occur to the skilled person and it will be understood that the invention is not limited to the described embodiments and encompasses modifications apparent to those skilled in the art lying within the spirit and scope of the claims appended hereto.

1.-78. (canceled)

79. A transaction management system for managing the purchase of products and/or services by buyers from sellers, the system comprising:
a data store for storing seller data comprising, for each of a plurality of sellers, a seller identifier and seller offer data indicating at least one product or service offered for sale;
a program store storing processor implementable instructions; and
a processor coupled to the data store and to the program store for implementing the stored instructions,
wherein the stored instructions comprise instructions for controlling the processor to implement a buyer interface to receive a purchase request from a buyer based on the seller offer data, thereby creating a transaction, the stored instructions further comprising instructions for controlling the processor to implement an investment interface to:
receive investment data from an investor, the investment data including a plurality of investment criteria for an investment fund, thereby creating the investment fund; and
provide the investment data to buyers and sellers able to meet the plurality of investment criteria for the investment fund.

80. The system of claim 79, wherein the data store is further for storing buyer data comprising, for each of a plurality of buyers, a buyer identifier, for each of a plurality of transactions, a transaction identifier, a buyer identifier, and a seller identifier and either a successfully completed transaction flag or a disputed problem transaction flag, for each of the plurality of sellers, a seller grade dependent on at least one of a number of successfully completed transactions involving the seller and a number of disputed problem transactions involving the seller.

81. The system of claim 79, wherein the system is for managing the purchase of services by buyers from sellers and the seller offer data for a seller further includes an availability record for the service offered for sale and the buyer interface is implemented to:
receive a purchase inquiry from a buyer, the purchase inquiry comprising a plurality of purchase criteria;
output seller offer data for a plurality of sellers able to meet the purchase criteria; and receive the purchase request from the buyer accepting an offer, thereby creating the transaction.

82. The system of claim 79, wherein the investment interface is further implemented to:
receive monetary currency from the investor for the investment fund
provide the investment data for the investment fund to other investors; and
receive monetary currency from one or more of the other investors for the investment fund.

83. The system of claim 79, wherein the investment criteria for an investment fund comprise one or more of:
a functional criterion defining the function of the monetary currency in the investment fund;
an eligibility criterion defining potential recipients of the monetary currency in the investment fund;
an allocation criterion defining how the monetary currency in the investment fund is to be allocated to recipients;
a payback criterion defining how the recipients are to repay the monetary currency they receive;
a spending criterion defining how the monetary currency in the investment fund is to be allocated to the recipients; and
a penalty criterion defining penalties to be imposed on a recipient failing to meet payback criteria.

84. The system of claim 79, wherein the investment criteria comprise a functional criterion which is at least one of investment in a buyer or seller, lending to a buyer or seller, or underwriting the transactions of a buyer or seller.

85. The system of claim 79, wherein the investment criteria comprise an eligibility criterion which is at least one of a market limitation, a geographical limitation, a seller or buyer grade limitation, a maximum outstanding liabilities limitation and a minimum endorsing grade points limitation.

86. The system of claim 79, wherein the investment criteria comprise an allocation criterion which comprises a payout limitation and an indication of whether and/or when repayment of monetary currency by the recipient is required.

87. The system of claim 79, wherein the investment criteria comprise a payback criterion which comprises at least one of a fixed rate per unit of time repayment requirement, a floating rate per unit of time repayment requirement and a deduction from earnings requirement.

88. The system of claim 79, wherein the payback criterion comprise a floating rate per unit of time repayment requirement, the floating rate to be determined by a falling price mechanism.

89. The system of claim 79, wherein the investment criteria comprise a spending criterion which comprises at least one of a market limitation, a geographical limitation and a permissible sellers limitation.

90. The system of claim 79, wherein the investment criteria comprise a penalty criterion which comprises at least one of a loss of recipient's grade penalty and a contractually enforced penalty.

91. The system of claim 79, wherein the penalty criterion may further comprise a transfer to another investment fund penalty, non-compliance with a payback criterion to result in the transfer of the recipient's debt to another investment fund having a different payback criterion.

92. The system of claim 79, wherein the penalty criterion may further comprise a loss of an endorser's grade penalty, non-compliance with a payback criterion to result in the loss of an endorser's grade, the endorser having endorsed the recipient.

93. The system of claim 79, wherein the investment interface is further implemented to receive an automated investment request from the buyer or seller, the automated investment request indicating acceptable investment offer criteria in respect of future transactions involving the buyer or seller.

94. The system of claim 79, wherein the stored instructions further comprise instructions for controlling the processor, on receipt of the automated investment request, to transfer monetary currency from an investment fund to a transaction involving the buyer or seller, the monetary currency being for financing or underwriting the transaction.

95. The system of claim 79, wherein the stored instructions further comprise instructions for controlling the processor to monitor compliance by the recipient with a payback criterion of the investment fund.

96. The system of claim 79, wherein the stored instructions further comprise instructions for controlling the processor, in the case of a payback criterion comprising a deduction from earnings requirement for a seller, to monitor for acceptable availability and pricing for the products and/or services of the seller.

97. The system of claim 79, wherein the investment interface is further implemented to provide:
investment performance data for a plurality of investment funds to investors, the investment performance data being presented in comparative form,
utilisation data for the plurality of sectors or geographies of the market to investors, the utilisation data being presented in comparative form, and
investment opportunity data based on the investment performance data and utilisation data, the opportunity data indicating a plurality of investment opportunities and level of take up for each investment opportunity

98. The system of claim 79, wherein the stored instructions further comprise instructions for controlling the processor to automatically create investment funds having investment criteria based on at least one of the investment performance data, the utilisation data and the investment opportunity data.

99. The system of claim 79, wherein the investment interface is further implemented to:
receive upper investment data from an investor, the upper investment data including a plurality of upper investment criteria for an upper investment fund, thereby creating an upper investment fund;
receive monetary currency from at least one investor for the upper investment fund; and transfer monetary currency from the upper investment fund to at least one investment fund meeting the upper investment criteria for the upper investment fund.

100. The system of claim 79, wherein an investment fund is for payment of grants or welfare payments to buyers or sellers, payout of the grants or welfare payments depending on the conduct of the buyer or seller in the market, and payback of the grants or welfare payments not being required.

101. A method for managing the purchase of products and/or services by buyers from sellers, the method comprising:
storing in a data store seller data comprising, for each of a plurality of sellers, a seller identifier and seller offer data indicating at least one product or service offered for sale;
implementing a buyer interface to receive a purchase request from a buyer based on the seller offer data, thereby creating a transaction; and
implementing an investment interface to: receive investment data from an investor, the investment data including a plurality of investment criteria for an investment fund, thereby creating the investment fund; and
provide the investment data to buyers and sellers able to meet the plurality of investment criteria for the investment fund.

102. The method of claim 101, further comprising storing in the data store buyer data comprising:
for each of a plurality of buyers, a buyer identifier,
for each of a plurality of transactions, a transaction identifier, a buyer identifier, and a seller identifier, a successfully completed transaction flag or a disputed problem transaction; and
for each of the plurality of sellers, a seller grade dependent on at least one of a number of successfully completed transactions involving the seller and a number of disputed problem transactions involving the seller.

103. The method of claim 101, wherein the method is for managing the purchase of services by buyers from sellers and the seller offer data for a seller further includes an availability record for the service offered for sale.

104. The method of claim 101, wherein implementing the buyer interface comprises implementing the buyer interface to:
receive a purchase inquiry from a buyer, the purchase inquiry comprising a plurality of purchase criteria;
output seller offer data for a plurality of sellers able to meet the purchase criteria; and receive the purchase request from the buyer accepting an offer, thereby creating the transaction.

105. The method of claim 101, further comprising storing in the data store investment data comprising, for each of a plurality of investment funds, an investment fund identifier, the respective investment criteria, one or more investor identifiers and investor information including an amount of monetary currency received from each investor for the investment fund.

106. The method of claim 101, wherein the investment criteria for an investment fund comprise one or more of:
a functional criterion defining the function of the monetary currency in the investment fund;
an eligibility criterion defining potential recipients of the monetary currency in the investment fund;
an allocation criterion defining how the monetary currency in the investment fund is to be allocated to recipients;
a payback criterion defining how the recipients are to repay the monetary currency they receive;
a spending criterion defining how the monetary currency in the investment fund is to be allocated to the recipients; and
a penalty criterion defining penalties to be imposed on a recipient failing to meet payback criteria.

107. The method of claim 101, wherein the investment criteria comprise a functional criterion which comprises at least one of investment in a buyer or seller, lending to a buyer or seller, and underwriting the transactions of a buyer or seller.

108. The method of claim 101, wherein the investment criteria comprise an eligibility criterion which comprises at least one of a market limitation, a geographical limitation, a seller or buyer grade limitation, a maximum outstanding liabilities limitation and a minimum endorsing grade points limitation.

109. The method of claim 101, wherein the investment criteria comprise an allocation criterion which comprises a payout limitation and an indication of whether and/or when repayment of monetary currency by the recipient is required.

110. The method of claim 101, wherein the investment criteria comprise a payback criterion which comprises at least one of a fixed rate per unit of time repayment requirement, a floating rate per unit of time repayment requirement and a deduction from earnings requirement.

111. The method of claim 101, wherein the payback criterion comprises a floating rate per unit of time repayment requirement, the floating rate to be determined by a falling price mechanism.

112. The method of claim 101, wherein the investment criteria comprise a spending criterion which comprises at least one of a market limitation, a geographical limitation and a permissible sellers limitation.

113. The method of claim 101, wherein the investment criteria comprise a penalty criterion which comprises at least one of a loss of recipient's grade penalty and a contractually enforced penalty.

114. The method of claim 101, wherein the penalty criterion may further comprise a transfer to another investment fund penalty, non-compliance with a payback criterion to result in the transfer of the recipient's debt to another investment fund having a different payback criterion.

115. The method of claim 101, wherein the penalty criterion may further comprise a loss of an endorser's grade penalty, non-compliance with a payback criterion to result in the loss of an endorser's grade, the endorser having endorsed the recipient.

116. The method of claim 101, wherein the investment interface is further implemented to receive an automated investment request from the buyer or seller, the automated investment request:
indicates acceptable investment offer criteria in respect of future transactions involving the buyer or seller,
transfers monetary currency from an investment fund to a transaction involving the buyer or seller, the monetary currency being for financing or underwriting the transaction; and
comprises monitoring compliance by the recipient with a payback criterion of the investment fund,
comprises, where a payback criterion comprises a deduction from earnings requirement for a seller, monitoring for acceptable availability and pricing for the products and/or services of the seller.

117. The method of claim 101, wherein the investment interface is further implemented to provide:
investment performance data for a plurality of investment funds to investors, the investment performance data being presented in comparative form,
utilisation data for the plurality of sectors or geographies of the market to investors, the utilisation data being presented in comparative form; and
investment opportunity data based on the investment performance data and utilisation data, the opportunity data indicating a plurality of investment opportunities and level of take up for each investment opportunity.

118. The method of claim 101, further comprising automatically creating investment funds having investment criteria based on at least one of the investment performance data, the utilisation data and the investment opportunity data.

119. The method of claim 101, wherein the investment interface is further implemented to:
receive upper investment data from an investor, the upper investment data including a plurality of upper investment criteria for an upper investment fund, thereby creating an upper investment fund;
receive monetary currency from at least one investor for the upper investment fund; and
transfer monetary currency from the upper investment fund to at least one investment fund meeting the upper investment criteria for the upper investment fund.

120. The method of claim 101, further comprising managing a marketplace in positions in an investment fund, thereby allowing an investor to transfer a position in the investment fund to another investor.

121. The method of claim 101, wherein the functional criterion may further comprise underwriting the future price of transactions involving a buyer or seller.

122. The method of claim 101, wherein an investment fund is for payment of grants or welfare payments to buyers or sellers, payout of the grants or welfare payments depending on the conduct of the buyer or seller in the market, and payback of the grants or welfare payments not being required.

123. An investment management method for managing investment in an underlying marketplace, the marketplace facilitating the purchase of products and/or services by buyers from sellers, the investment management method comprising:
receiving investment data from an investor, the investment data including a plurality of investment criteria for an investment fund, thereby creating the investment fund; and
providing the investment data to buyers and sellers of the marketplace able to meet the plurality of investment criteria for the investment fund.

124. An investment management system for managing investment in an underlying marketplace, the marketplace facilitating the purchase of products and/or services by buyers from sellers, the investment management system comprising:
a program store storing processor implementable instructions; and
a processor coupled to the data store and to the program store for implementing the stored instructions,
wherein the stored instructions comprise instructions for controlling the processor to implement an investment interface to:
receive investment data from an investor, the investment data including a plurality of investment criteria for an investment fund, thereby creating the investment fund; and
provide the investment data to buyers and sellers of the marketplace able to meet the plurality of investment criteria for the investment fund.
